(19) United States
(12) Patent Application Publication
(10) Pub. No.: US 2003/0200101 A1
(43) Pub. Date: Oct. 23, 2003

(54) System and method for automating human resources programs

(76) Inventors: Siegfried C. Adler, Long Beach, NY (US); Alan N. Cohen, New York, NY (US); Michael C. Fleming, Huntington, NY (US); Rich Koudelka, Hicksville, NY (US); Moshe Molcho, Scarsdale, NY (US); Sheldon H. Sonnenblick, West Hempstead, NY (US)

Correspondence Address: PENNIE AND EDMONDS, 1155 AVENUE OF THE AMERICAS, NEW YORK, NY, 100362711

(21) Appl. No.: 10/125,277

(22) Filed: Apr. 18, 2002

(51) Int. Cl. G06F 17/60

(52) U.S. Cl. 705/1; 705/2

(57) ABSTRACT

The present invention relates to a system and method for automating human resource programs. In a preferred example embodiment, the present invention comprises an employee benefits communication system further comprising an electronic database of benefits plan information, a Web server program executing on a Web server computer connected to the Internet, configured to authenticate users as brokers of employee benefits plans, an application program executing on the Web server computer to update the database of benefits information in response to HTTP requests transmitted by authenticated brokers, a Web site generation program that queries the database and incorporates information updated by brokers into text files comprising XML and employee benefits plans information, a Web server program executing on a Web server computer connected to the Internet, configured to authenticate users as participants in an identified employee benefits plan and to transmit text files corresponding to the identified employee benefits plan in response to HTTP requests transmitted by authenticated participants in the identified employee benefits plan.

### FIELD OF THE INVENTION

The present invention generally relates to the field of web applications for generating and maintaining a web site that provides human resource information.

### BACKGROUND OF THE INVENTION

Many large corporations provide medical, dental, and other benefits for their employees. Often, employees need to access their benefits information and file forms with benefits plans companies. Many employers have automated these processes by making benefits information accessible to employees via a local area network or Web site. However, employers that want or have Web sites for benefits information find that assembling, updating and maintaining such Web sites is expensive and difficult. Providing customized portions of their web site for specific users is even more difficult and expensive.

Often, brokers responsible for selling benefits plans to employers possess the detailed information necessary to create human resources Web sites for their corporate clients, but lack the technical proficiency needed to do so.

It is desirable to have a system and method for automating human resource programs wherein a user may generate and maintain a web site that provides benefits information and materials for employees of participating companies.

It is also desirable to have a system and method for automating human resource programs wherein a user may generate and maintain a web site that provides customized benefits information and materials to employees of participating companies.

It is further desirable to have a system and method for automating human resource programs wherein a user may access a web site that provides benefits information and materials specific to the user.

### SUMMARY OF THE INVENTION

The present invention relates to a system and method for automating human resource programs. The present invention comprises a web application running on a server system interconnected to a plurality of client systems via a communications network, such as the Internet. The present invention comprises four main aspects: (1) a knowledge maintenance aspect, (2) a news administration aspect, (3) a site creation aspect and (4) a site usage aspect. The knowledge maintenance aspect allows a user to maintain the databases that are used to build a web site. The news administration aspect allows a human resource administrator or a human resources broker to create and manage a web site comprising company specific or broker specific news items. The site creation aspect allows a broker or an administrator to complete an interactive questionnaire. The answers to the questionnaire and the information maintained at the server system are then used to automatically create a web site. The site usage aspect allows a user to enter a user ID in order to access a web site dedicated to the user's benefits information or benefits information for the user's company.

In one aspect, the invention comprises an employee benefits communication system comprising an electronic database of benefits plan information, a Web server program executing on a Web server computer connected to the Internet, configured to authenticate users as brokers of employee benefits plans, an application program executing on the Web server computer to update the database of benefits information in response to HTTP requests transmitted by authenticated brokers, a Web site generation program that queries the database and incorporates information updated by brokers into text files comprising HTML and employee benefits plans information, and a Web server program executing on a Web server computer connected to the Internet, configured to authenticate users as participants in an identified employee benefits plan and to transmit text files corresponding to the identified employee benefits plan in response to HTTP requests transmitted by authenticated participants in the identified employee benefits plan.

The present invention allows employers to create and maintain a web site that provides human resource information. Accordingly, employers may update their human resource web sites as information changes or becomes available. In addition, the present invention allows human resource administrators and benefits plan brokers to create and maintain a customized web site. Hence, administrators and brokers may create a web site that is tailored to their needs. Furthermore, because the present invention makes benefits information available via a web site, employees may access benefits information from any computer connected to a communications network, such as the Internet. Additional aspects and advantages will be apparent to one of ordinary skill in the art in view of the drawings, specification, and claims hereof.

### BRIEF DESCRIPTION OF THE DRAWINGS

These and other objects, features and advantages of the present invention will be more readily apparent from the following detailed description of the present invention in which:

FIG. 1 schematically illustrates a server system and a client system interconnected via a communications network;

FIG. 2 schematically illustrates a client system;

FIG. 3 schematically illustrates an example preferred server system of the present invention;

FIG. 4 schematically illustrates an example preferred web resources database;

FIG. 5 schematically illustrates an example preferred company information database;

FIG. 6 schematically illustrates an example preferred medical table of a benefits plan database;

FIG. 7 schematically illustrates an example preferred dental table of a benefits plan database;

FIG. 8 schematically illustrates a preferred STD, life plan, and 401(k) table of a benefits plans database;

FIG. 9 schematically illustrates example preferred tables of a contacts database;

FIG. 10 schematically illustrates example preferred tables of a frequently asked questions database;

FIG. 11 schematically illustrates example preferred tables of a forms database;

FIG. 12 schematically illustrates example preferred tables of a broker information database;

FIG. 13 schematically illustrates a flow chart of a developer's use of an example preferred embodiment of the system;

FIG. 14 illustrates an example preferred library maintenance page;

FIG. 15 illustrates an example Web resource maintenance page;

FIG. 16 schematically illustrates a flow chart of a broker's use of an example preferred embodiment of the system;

FIG. 17 schematically illustrates a portion of a flow chart of Website creation in an example preferred embodiment of the system;

FIG. 18 schematically illustrates a portion of a flow chart of Website creation in an example preferred embodiment of the system;

FIG. 18a illustrates an example preferred broker Website creation page;

FIG. 19 illustrates a portion of an example preferred medical plan questionnaire form;

FIG. 20 illustrates a portion of an example preferred medical plan questionnaire form;

FIG. 21 illustrates a portion of an example preferred medical plan questionnaire form;

FIG. 22 illustrates a portion of an example preferred medical plan questionnaire form;

FIG. 23 illustrates a portion of an example preferred medical plan questionnaire form;

FIG. 24 illustrates a portion of an example preferred medical plan questionnaire form;

FIG. 25 illustrates a portion of an example preferred dental plan questionnaire form;

FIG. 26 illustrates a portion of an example preferred dental plan questionnaire form;

FIG. 27 illustrates a portion of an example preferred dental plan questionnaire form;

FIG. 28 illustrates a portion of an example preferred 401(k) plan questionnaire form;

FIG. 29 illustrates a portion of an example preferred disability plan questionnaire form;

FIG. 30 illustrates a portion of an example preferred life insurance plan questionnaire form;

FIG. 31 schematically illustrates a portion of a flow chart of Website creation in an example preferred embodiment of the system;

FIG. 32 schematically illustrates a flow chart of use of an example preferred benefits information Web site generated using the system;

FIG. 33 illustrates an example preferred welcome page of a benefits information Web site generated using the system;

FIG. 34 illustrates an example preferred medical plan benefits information page of a benefits information Web site generated using the system;

FIG. 35 illustrates an example preferred medical plan benefits information details page of a benefits information Web site generated using the system;

FIG. 36 illustrates an example preferred medical plan frequently-asked-questions page of a benefits information Web site generated using the system;

FIG. 37 illustrates an example preferred dental plan benefits information page of a benefits information Web site generated using the system;

FIG. 38 illustrates an example preferred dental plan benefits information details age of a benefits information Web site generated using the system;

FIG. 39 illustrates an example preferred dental plan frequently-asked-questions page f a benefits information Web site generated using the system;

FIG. 40 illustrates an example preferred 401(k) plan benefits information page of a benefits information Web site generated using the system;

FIG. 41 illustrates an example preferred 401(k) plan benefits information details page of a benefits information Web site generated using the system;

FIG. 41a illustrates an example preferred other insurance plan benefits information page of a benefits information Web site generated using the system;

FIG. 42 illustrates an example preferred Web resources page of a benefits information Web site generated using the system;

FIG. 43 illustrates an example preferred forms page of a benefits information Web site generated using the system;

FIG. 44 illustrates an example preferred news page of a benefits information Web site generated using the system;

FIG. 45 illustrates an example preferred contacts information page of a benefits information Web site generated using the system;

FIG. 46 illustrates an example preferred company information questionnaire form page of the system;

FIG. 47 illustrates an example preferred login setup form page of the system.

FIG. 48 schematically illustrates an interaction between the system, a broker, benefits provider, employer and employee.

FIGS. 49A-49D illustrates an example preferred benefits plan comparison chart.

FIG. 50 schematically illustrates an example preferred plan tour.

FIGS. 51A-51D illustrates an example preferred benefits plan tips page.

### DETAILED DESCRIPTION OF THE INVENTION

The present invention relates to a system and method for automating human resource communications. The invention will be described with reference to an example preferred embodiment, referred to as the Complete Human Resource System or CHRS. In the preferred Complete Human Resource example embodiment, a user may automatically create and maintain a web site that provides benefits information, news, and forms. A user may also create and access a web site comprising benefits information customized to a user.

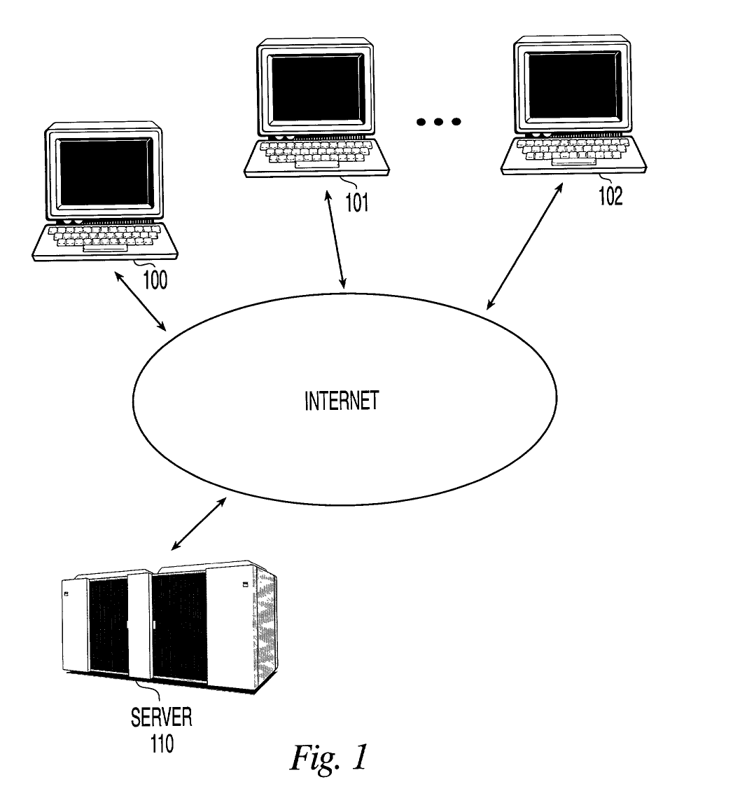

FIG. 1 schematically illustrates server system 110 as connected to a plurality of client computer systems such as 100, 101, 102 via a communications network, such as the 110 Internet.

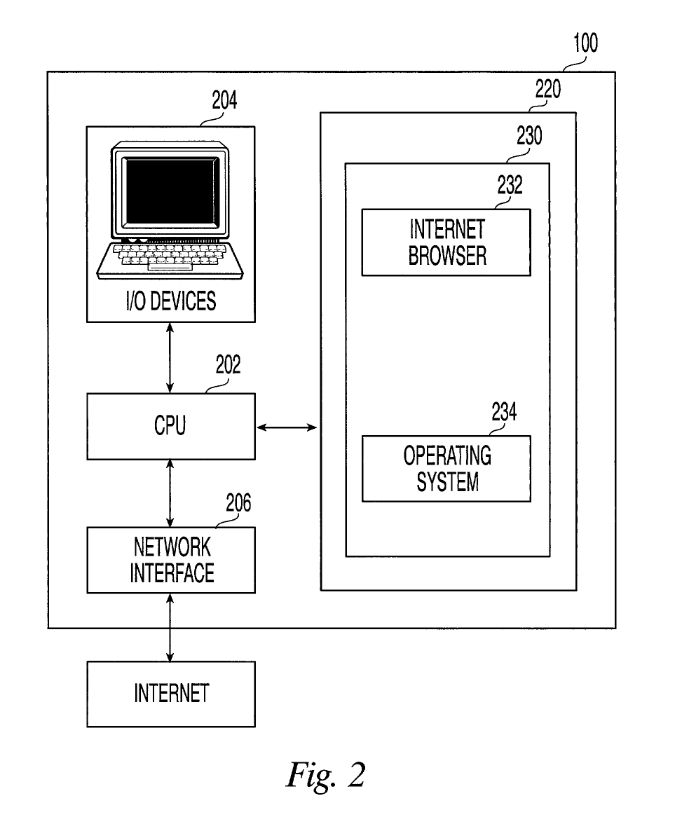

FIG. 2 schematically illustrates an example client system 100. Client system 100 may comprise any computer system that allows a user to access the server system 110. For example, client system 100 may be a programmed general purpose computer that includes a processor 202, I/O devices 204 such as a monitor, a mouse, and a keyboard, a communications network interface 206 such as an ethernet interface that allows the computer to access server system 110, memory 220 (which may comprise both volatile memory such as RAM and non-volatile memory such as a disk drive), and data comprising computer programs 230, including an Internet browser 232 and an operating system 234, that allow client system 100 to operate in accordance with the invention.

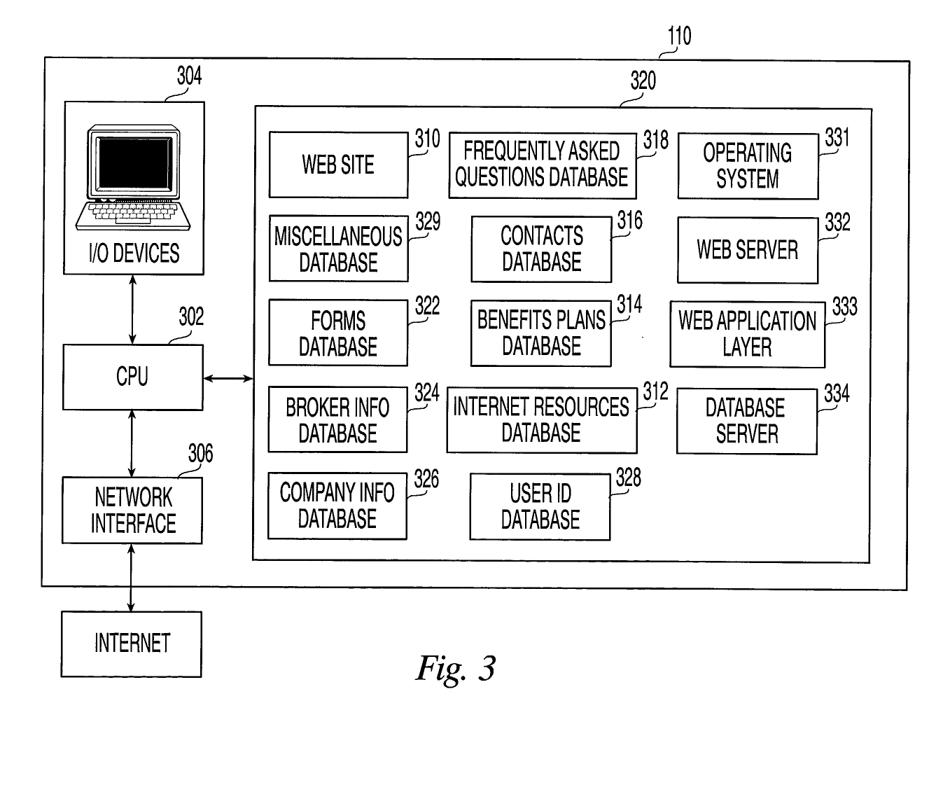

FIG. 3 schematically illustrates a preferred server system 110 of the present invention. As is shown in FIG. 3, server system 110 is preferably a general purpose computer that includes a processor 302, memory 320 (which may comprise both volatile memory such as RAM and non-volatile memory such as a disk drive), and computer programs and data, including an operating system 331, and a system Web site 310 that is accessible via the Internet. Server system memory 320 preferably includes: a web resources database 312, a benefits plans database 314, a contacts database 316, a frequently asked questions database 318, a forms database 322, a broker information database 324, a company information database 326, a user ID database 328, operating system 331, Web server 332, Web application layer 333, and database server 334. Preferably operating system 331 comprises Microsoft Windows 2000, Web server 332 comprises Microsoft Internet Information Server version 4.0, Web application layer 333 comprises Microsoft Active Server Pages, and database server 334 comprises Microsoft SQL Server. It will be apparent to those of skill in the art that the various portions of the system may reside on a plurality of interoperating computers.

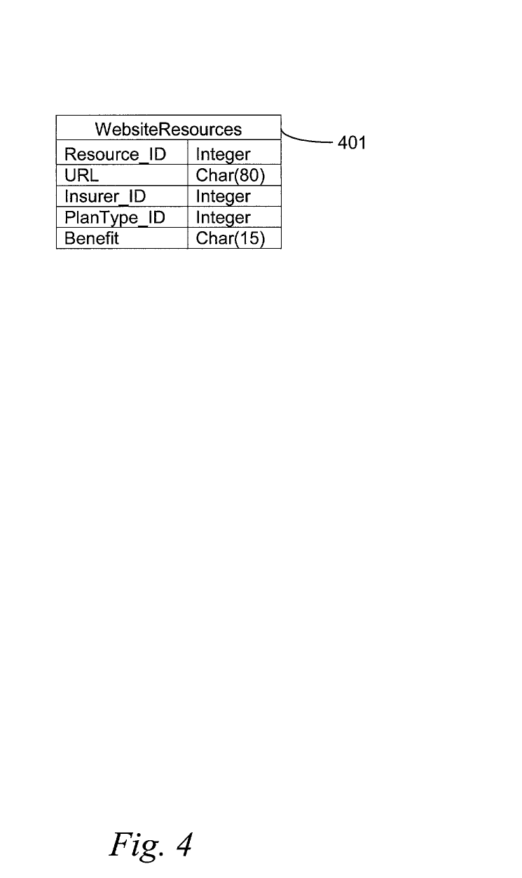

FIG. 4 schematically illustrates the data fields of a table of the Web resources database 312. Preferably, Web resources database 312 stores Universal Resource Locators (“URLs”) for Web pages and Web sites containing information relevant to benefits plans supported by the system. As shown in FIG. 4, the Web resources database preferably comprises a WebResources table 401, further comprising rows including a URLFileName pointer to a file containing a Uniform Resource Locator for a Web page or Web site, a BenefitType field describing the type of benefit to which the Web page or Web site relates, a primary key Resource_ID and foreign keys Insurer_ID and planType_ID.

As is generally case in the tables described herein, an _ID suffix to a field indicates that the field contains a key to an index on a table in a database of the system, allowing fast access to the indexed information. Field names are generally descriptive of the contents of the field.

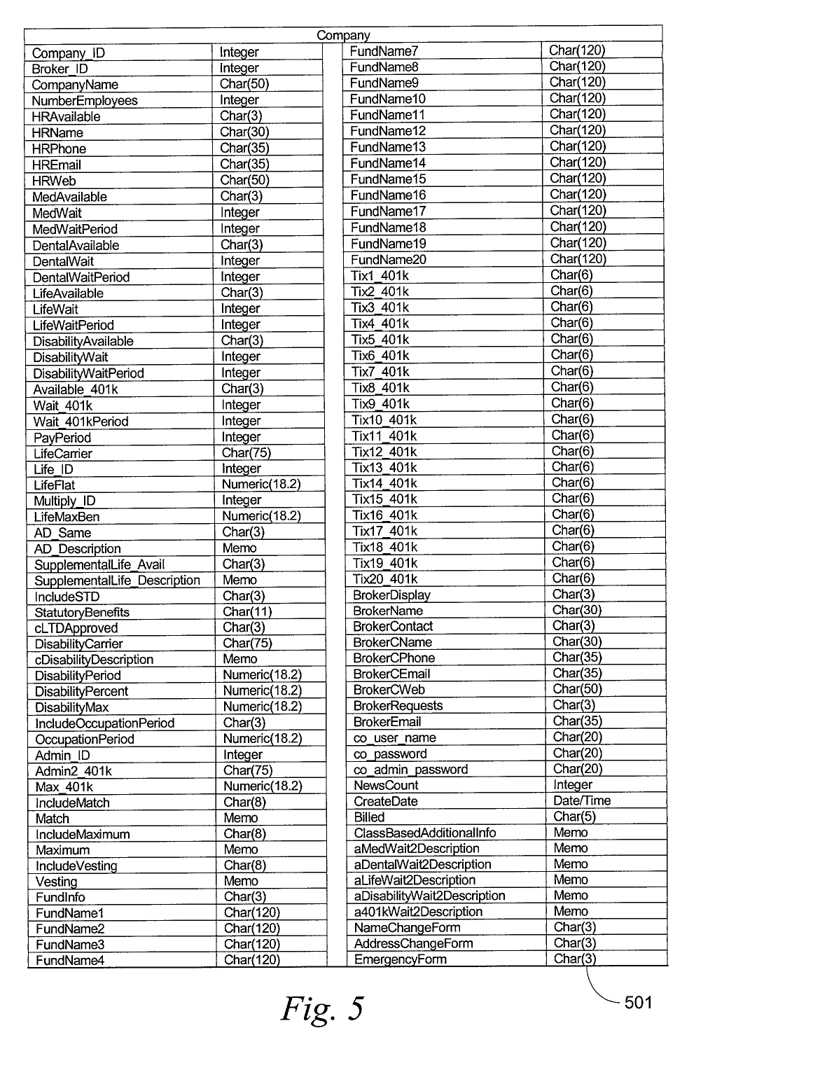

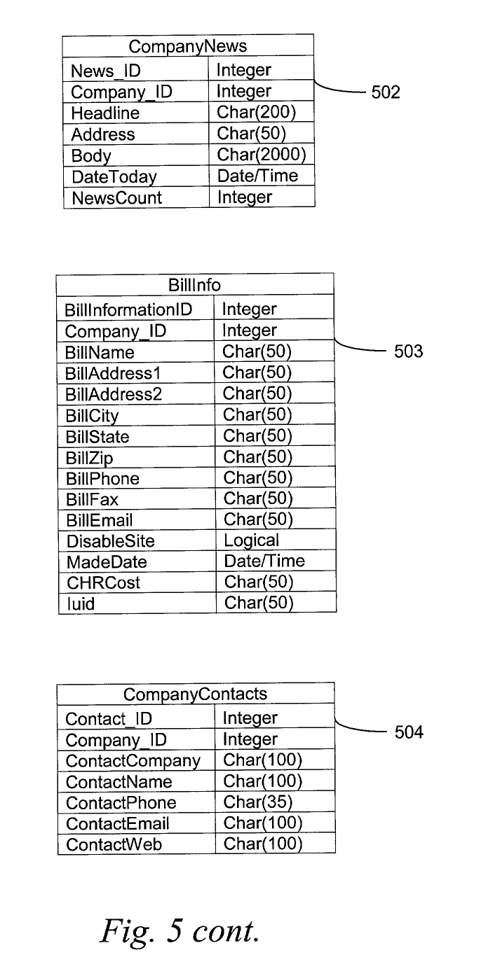

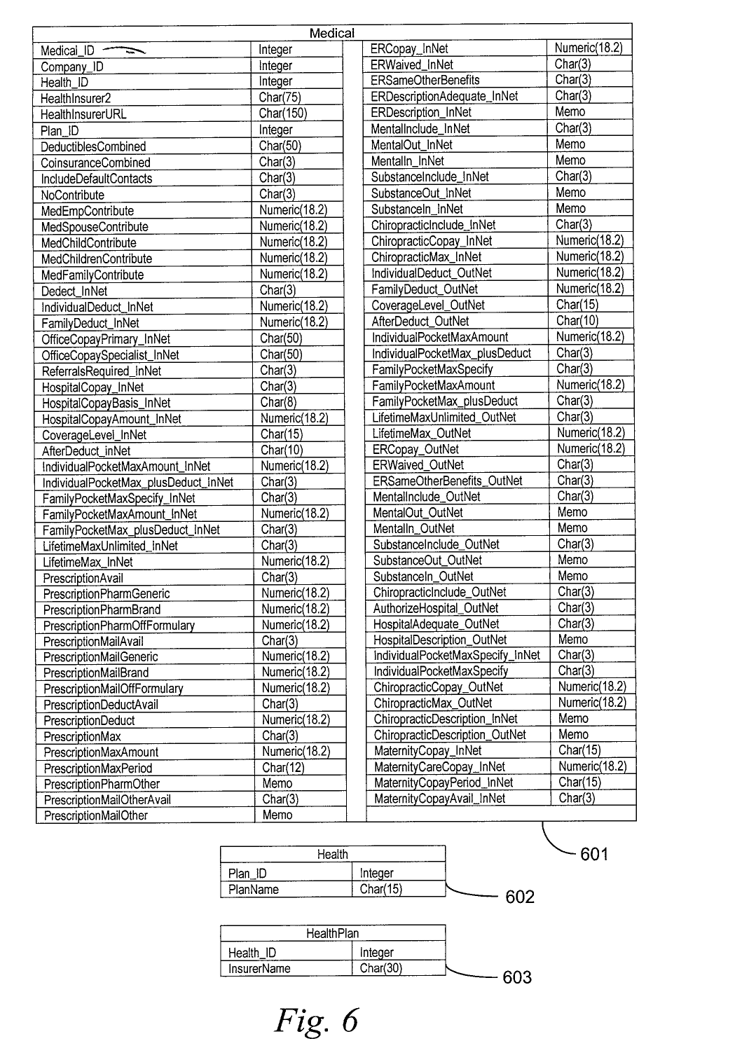

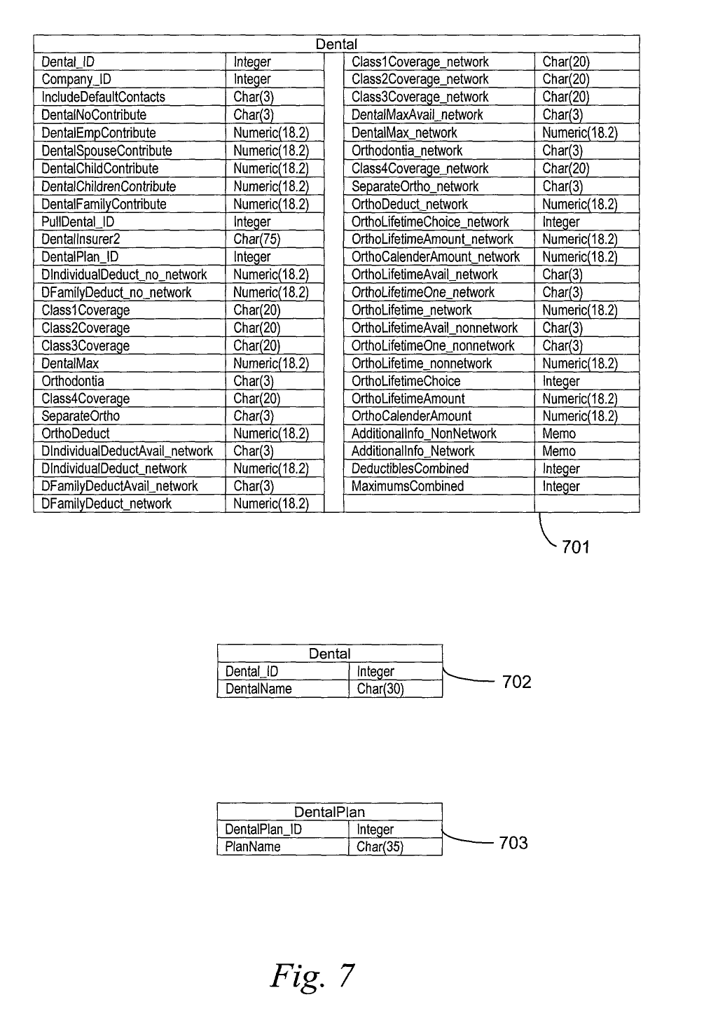

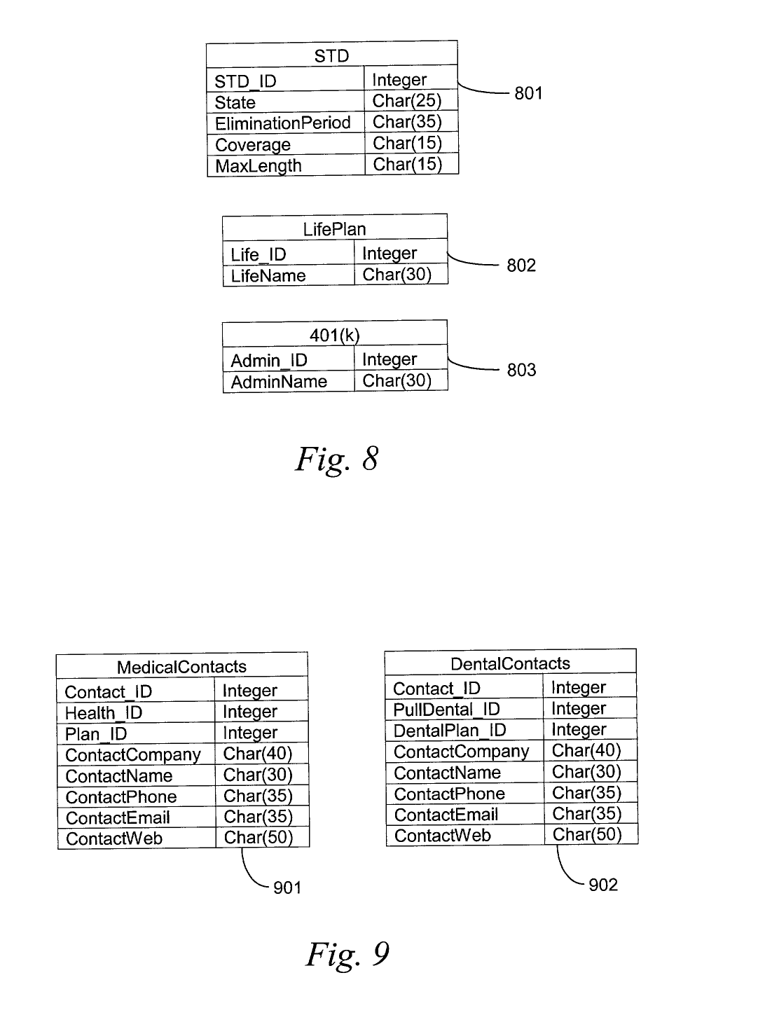

In the preferred CHRS example embodiment, benefits plans database 314 comprises information on a plurality of specific benefits plans. FIGS. 5-8 schematically illustrate tables comprising the benefits plans database 314, including Company table 501, CompanyNews table 502, BillInfo table 503, CompanyContacts table 504, Medical table 601, Health table 602, HealthPlan table 603, Dental tables 701, 702, a DentalPlan table 703, a STD table 801, a Life Plan table 802, and a 401(k) table 803.

The CHRS Contacts Database 316 comprises contact information for persons involved in the administration of benefits plans supported by the CHRS system. FIG. 9 schematically illustrates tables comprising the preferred Contacts Database 316, including a MedicalContacts table 901 and a DentalContacts table 902. These tables may be accessed using the identifiers for the particular contact (Contact_ID), the particular health or dental carrier (Health_ID or Dental_ID respectively) or particular benefits plan (Plan_ID or DentalPlan_ID) for which the contact information is provided.

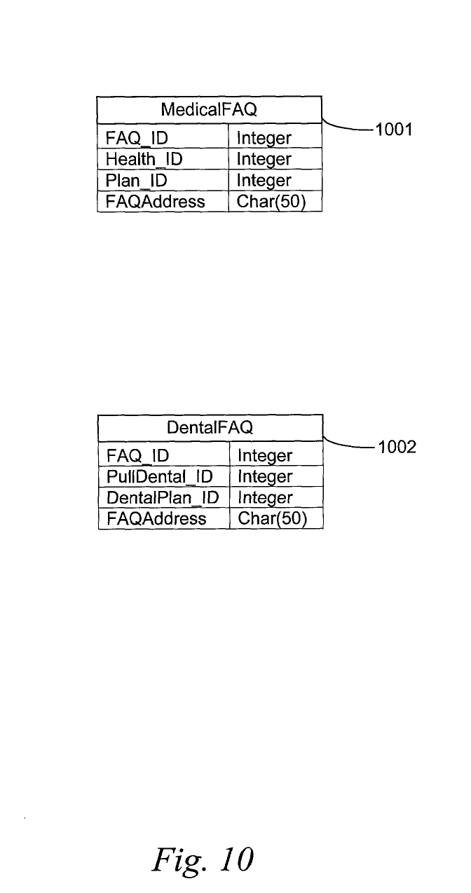

The CHRS Frequently Asked Questions Database 308 comprises pointers to files, called FAQs, comprising frequently asked questions and corresponding answers concerning benefits plans stored in HTML format for display via Web server 332. FIG. 10 schematically illustrates the tables comprising the Frequently Asked Questions Database 308, including a MedicalFAQ table 1001 and a DentalFAQ table 1002. Frequently asked questions files may be accessed using the identifiers for the particular frequently FAQ (FAQ_ID), the particular plan provider (Health_ID or Dental_ID) or particular benefits plan (Plan_ID or DentalPlan_ID) for which the FAQ is provided.

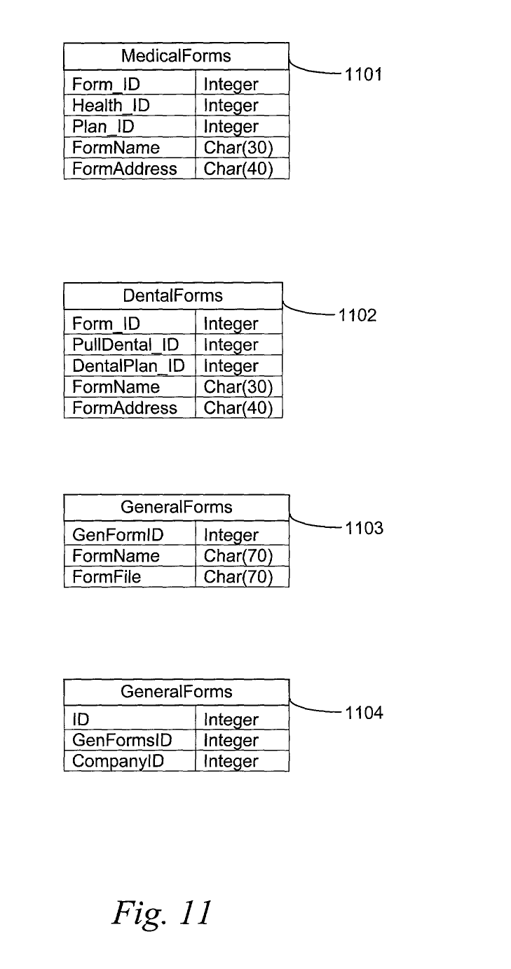

The CHRS Forms Database 322 comprises pointers to files containing forms needed in connection with benefits plans supported by the CHRS system. FIG. 11 schematically illustrates the tables comprising the Forms Database 322, including MedicalForms table 1101, DentalForms table 1102, GeneralForms table 1103 and GeneralForms_Part table 1104. Medical and Dental forms files may be accessed using the identifiers of the particular form (Form_ID), particular plan provider (Health_ID or Dental_ID), or particular benefits plan (Plan_ID) for which the forms are provided. General Forms not specific to a particular plan or provider may be accessed by the identifier for the form (GenFormID) using the GeneralForms table. Multiple forms associated with a single company may be accessed using the GeneralForms_Part table, using the company identifier (CompanyID).

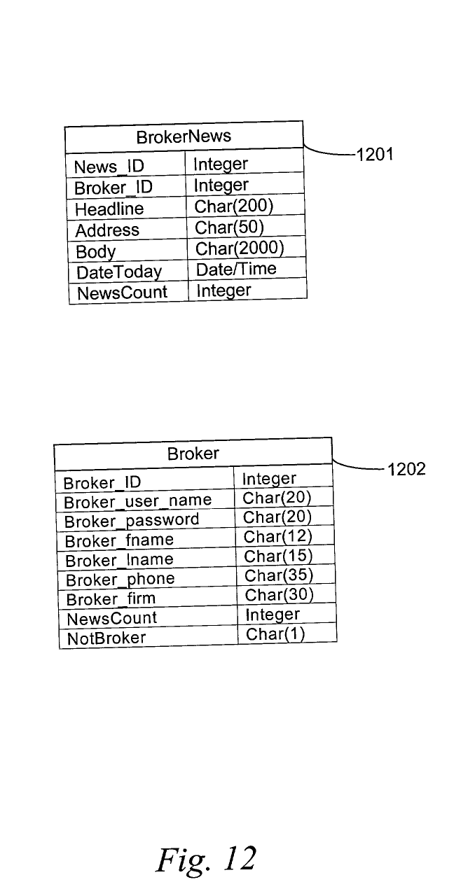

The CHRS Broker Info Database 324 comprises contact information and news concerning brokers of benefits plans supported by the CHRS system. FIG. 12 schematically illustrates the tables comprising the Broker Info Database 324, including BrokerNews table 2101 and the Broker table 1202. News items including headlines and article bodies may be accessed using the BrokerNews table 1201 and identifiers for the news item (News ID) or broker (Broker_ID). The Broker table 1202 is used to store credentials for broker authentication when brokers seek to administer the system, as described more fully below, and contact information for the broker.

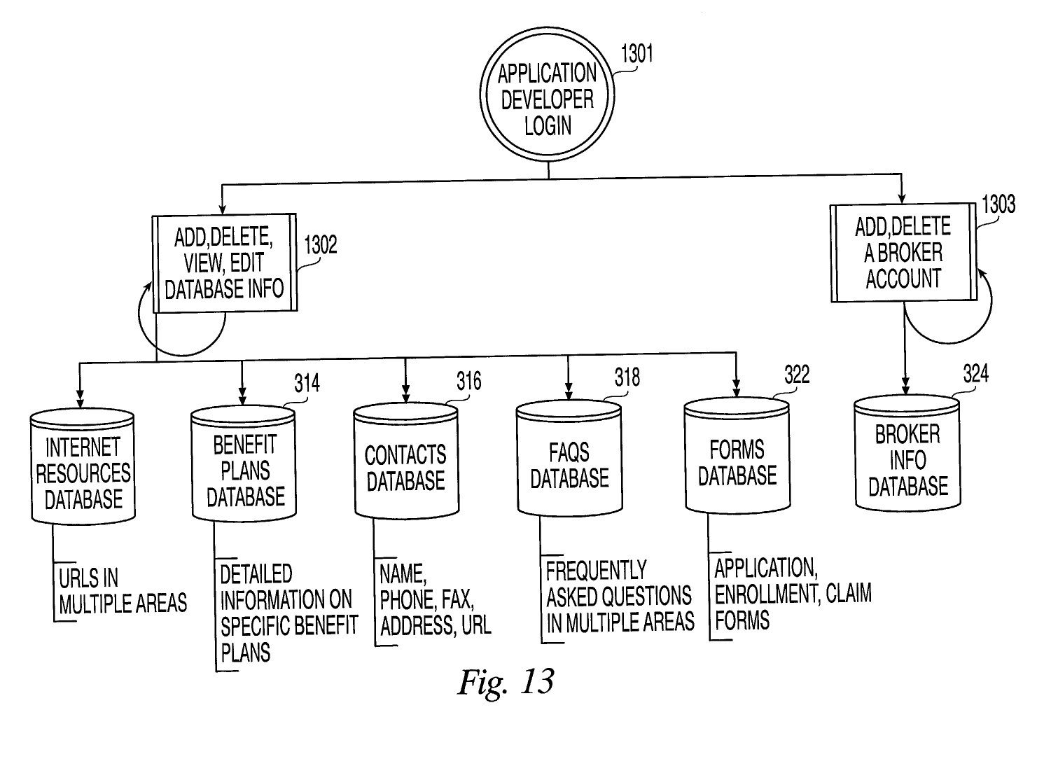

The Web resources database 312, Benefits Plans database 314, Contacts database 316, Frequently Asked Questions database 318 and Forms database 322 are maintained through an application developer Web interface, as schematically illustrated in FIG. 13. The application developer Web interface is also used to add and delete broker accounts 1303.

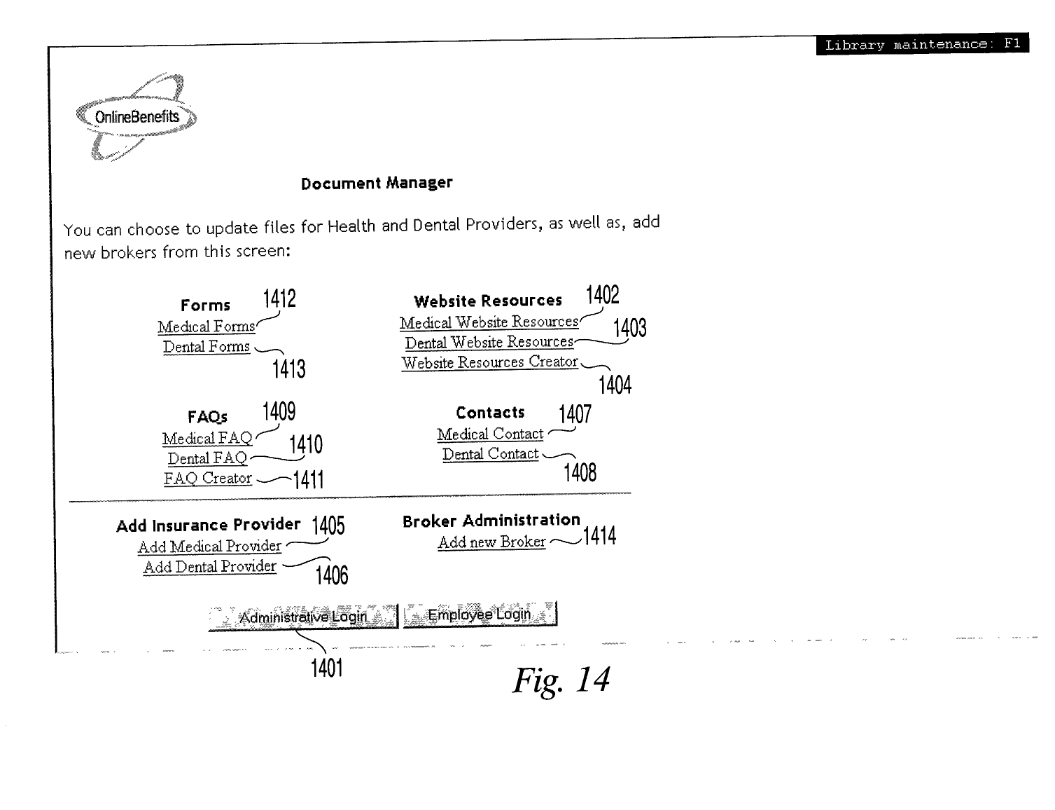

To perform library maintenance, the application developer logs in using the Administrative Login 1401 button illustrated in FIG. 14. Credentials are requested by the developer's browser and relayed to the system using conventional HTTP or HTTPS authentication mechanisms. Once authenticated, the developer may add, delete, view, or edit 1301 information in the Web Resources database 312 using Website resources links 1402, 1403, 1404, or information in the Benefits Plans database 314 using Add Insurance Provider links 1405, 1406, or information in the Contacts database 316 using Contacts links 1407, 1408, or information in Frequently Asked Questions database 318 using FAQs links 1409, 1410, 1411, or information in the Forms database 322 using Forms links 1412, 1413. The developer may also add or delete information in the Broker database 324 using Broker Administration link 1414.

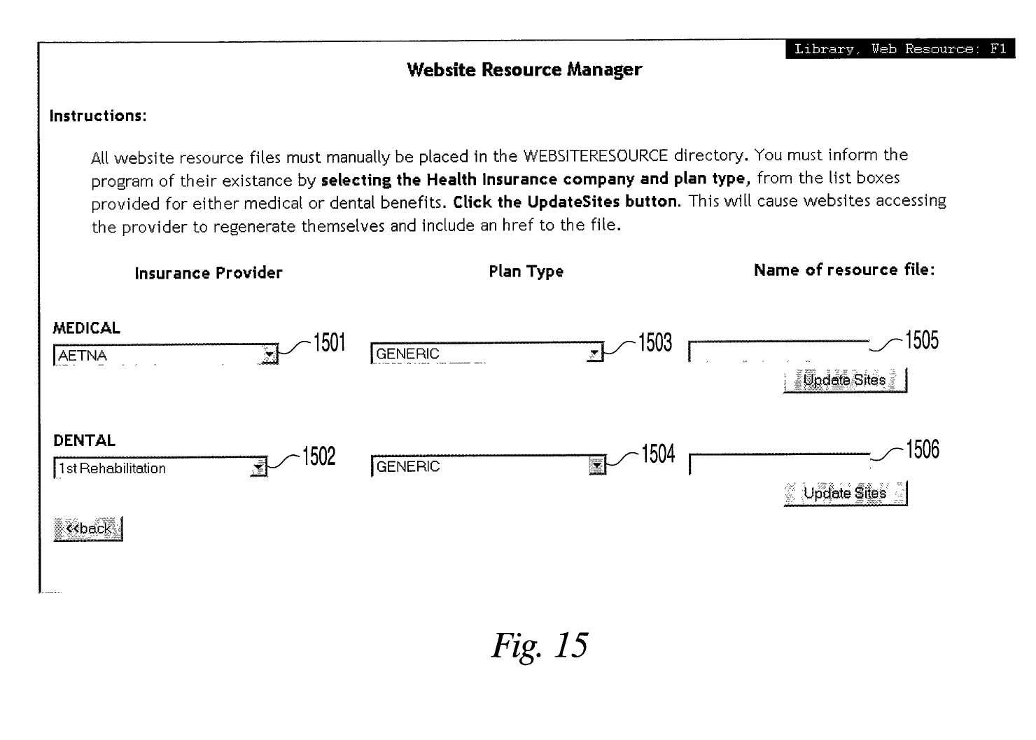

For example, selecting Website resources links 1402, 1403 or 1404 causes the system to display the Website Resources Manager display shown in FIG. 15. Using the Insurance Provider pull-down menus 1501, 1502 of Website Resources Manager, the developer may specify the InsurerID field of WebsiteResources table 401, and using the Plan Type pull-down menus 1503, 1504 the user may specify the PlanType_ID field of the WebsiteResources table 401. Using the Name of resource file text boxes 1505, 1506, the user may enter or update the URLFileName field of a corresponding record of the WebsiteResources table 401. Selecting the Update Sites buttons 1507, 1508 causes the system to generate or regenerate Web site pages including the updated Website resources.

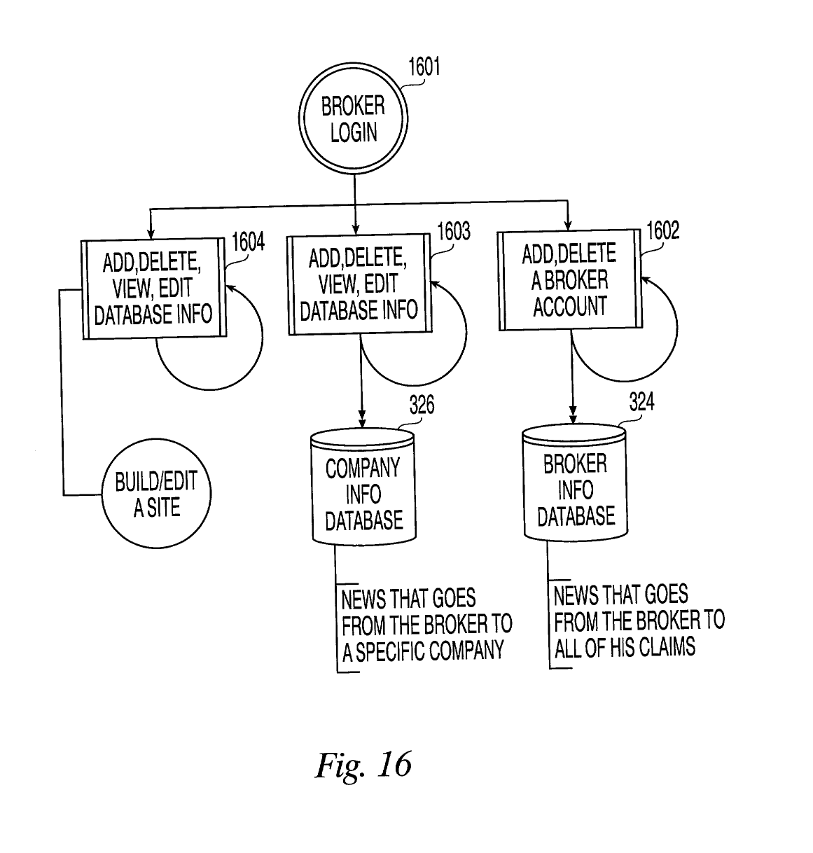

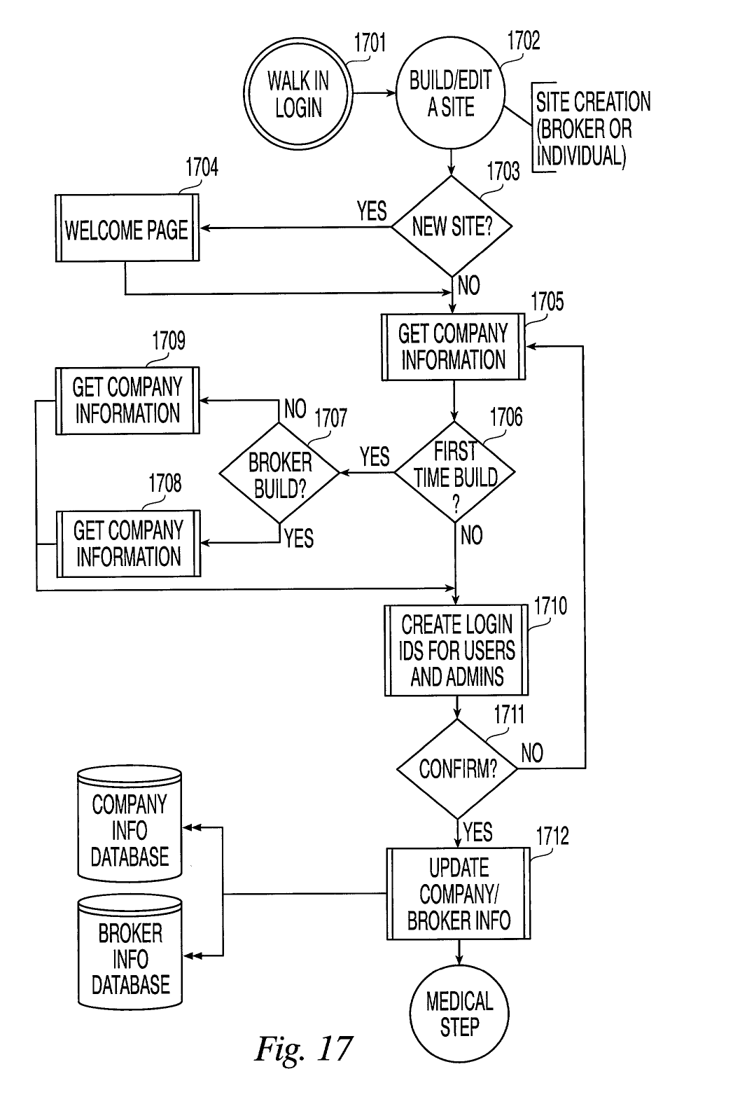

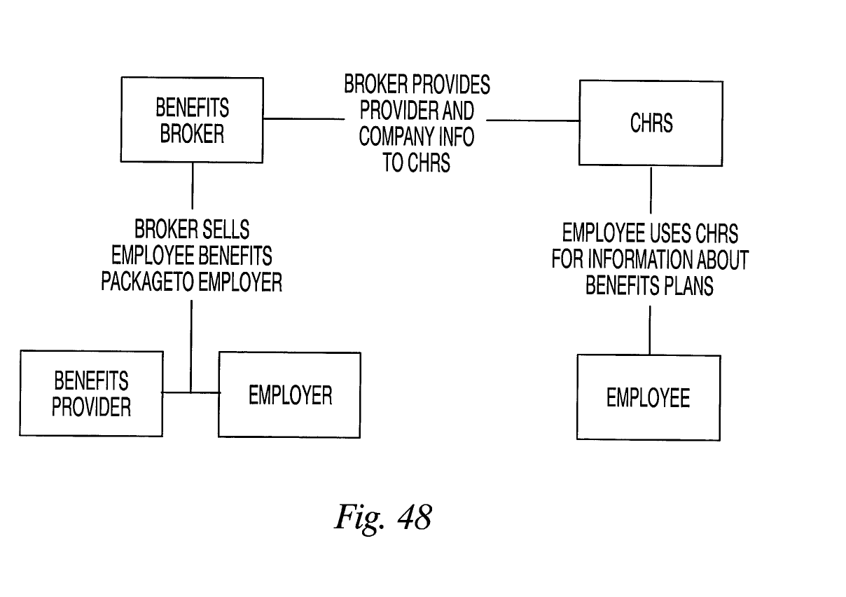

Other users of the system, typically benefits plans brokers, may use the system to generate human resources communication, as schematically illustrated in FIG. 48. Web sites for their customers. As schematically illustrated in FIG. 16, after logging into the system as a broker, a broker may use the system to add, delete, view or edit broker specific news 1602 in the broker information database 324 and company specific information 1603 in the company information database 326. The system will then provide broker information automatically to all of the users of the system who are affiliates of the broker's customers, such as employees broker customers. Similarly, the system will provide company specific information to all of the users of the system who are affiliates of the company such as employees.

Users such as brokers may also use the system to create, delete, view and modify benefits plans human resources information Web sites 1604 for companies that are customers of the broker.

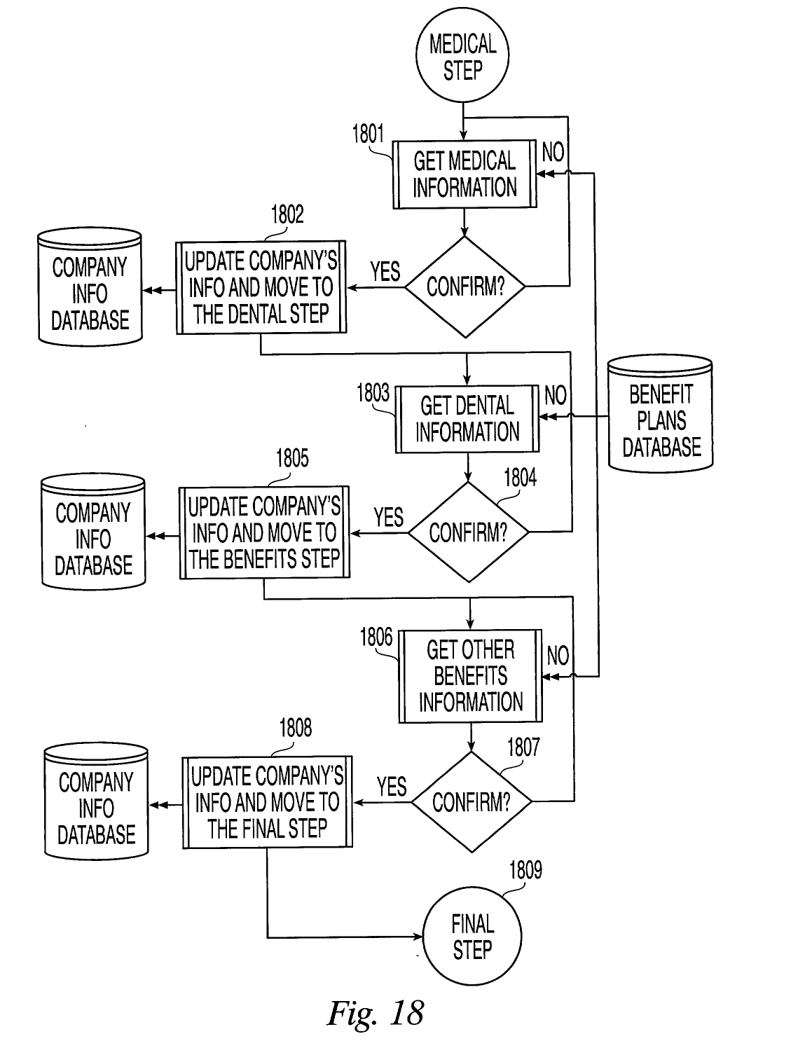

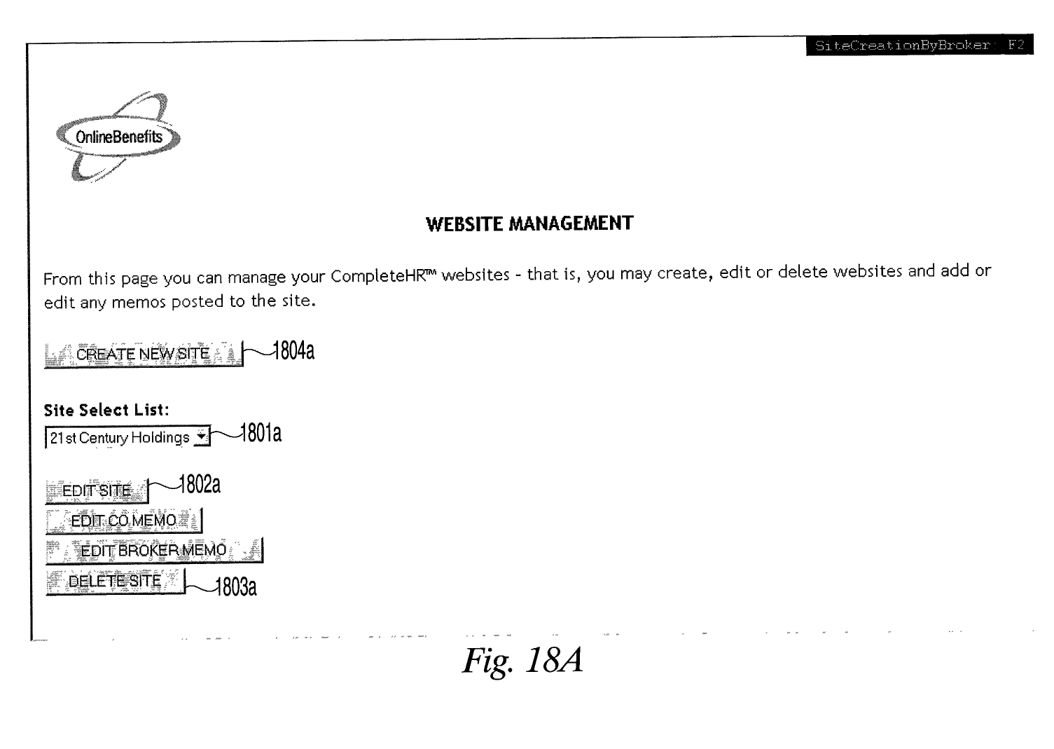

The company Web site creation process is schematically illustrated in more detail in FIG. 17. When a broker logs in, the system uses the broker user name and password to retrieve the BrokerID from the Broker table 1202. The system then queries company table 501 using BrokerID to retrieve a list of companies for which the broker is responsible. The list is used to populate pull-down menu 1801 in FIG. 18a with a list of companies for which the broker is responsible, generated by querying company information database 326 using the brokerID determined from the broker's login. The broker may select one of these companies and edit or delete the site using Edit Site button 1802a or Delete Site button 1803a, respectively.

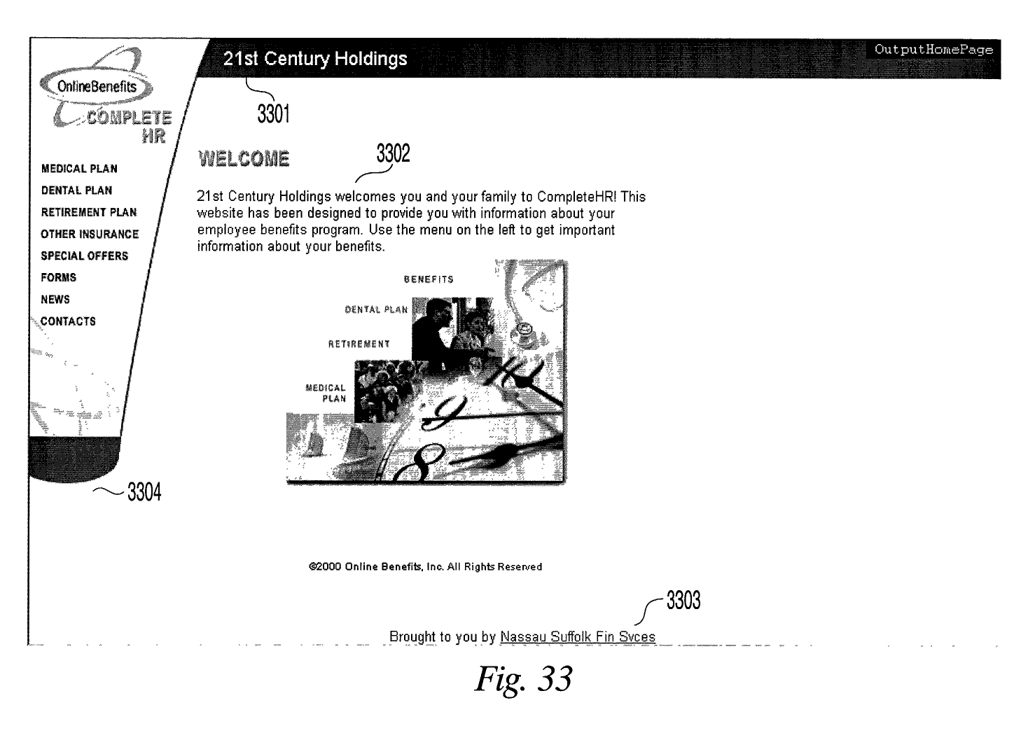

If the broker selects 1702 the Create New Site button 1804, the system determines whether the site to be created is a new site 1703. If the site is new, the system generates a welcome page for the site 1704. An example preferred welcome page is illustrated in FIG. 33. After the welcome page is created, or if the site is not new, the system prompts the user for company information 1705.

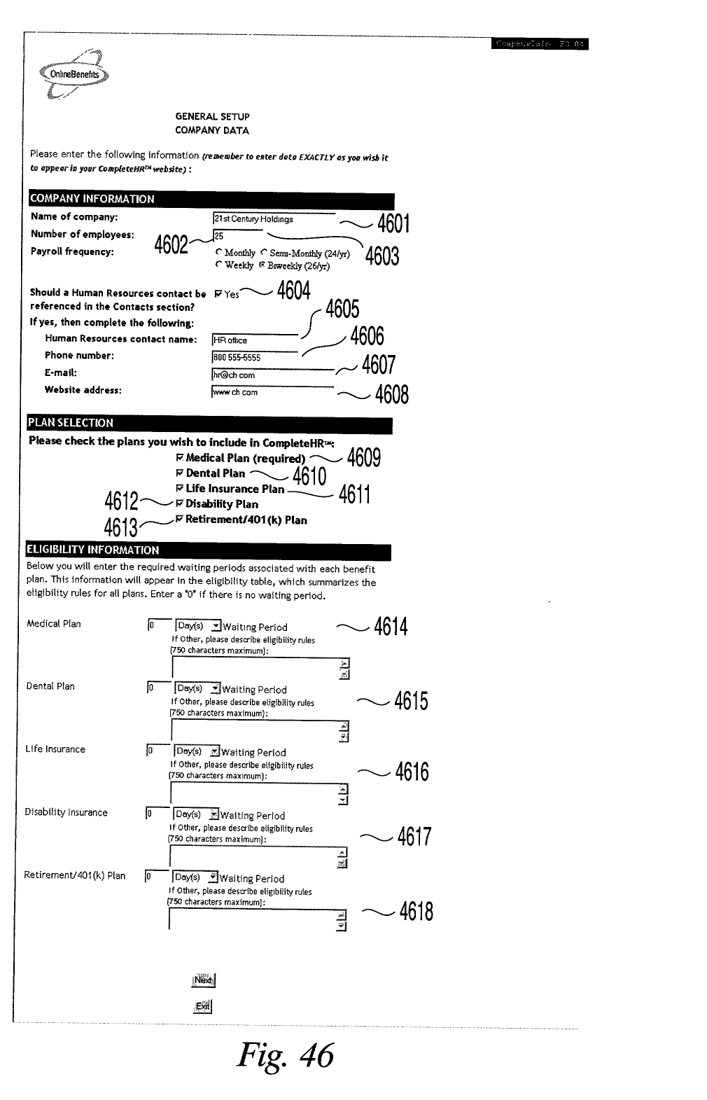

An example preferred Web form for entering company information is illustrated in FIG. 46. Fields are provided for the company name, number of employees 4602, payroll frequency 4603, human resources contact information 4604-4608, and types of benefits plans to be included in the Web site, such as medical plan 4609, dental plan 4610, life insurance plan 4611, disability plan 4612 and 401(k) or retirement plan 4613. Fields for indicating waiting periods for eligibility to participate in the plans designated in fields 4609-4613 are provided in fields 4614-4618.

Returning to FIG. 17, after receiving company information from the user 1705, the example preferred system determines whether a Web site for the company has been built using the system before 1706. If not, the system then determines whether the Web site is being created by a broker or another type of user 1707. If the Web site is being built by a broker, the system queries the broker for information about the broker 1708. Otherwise, the system queries the user for billing information for the company for which the Web site is being built 1709.

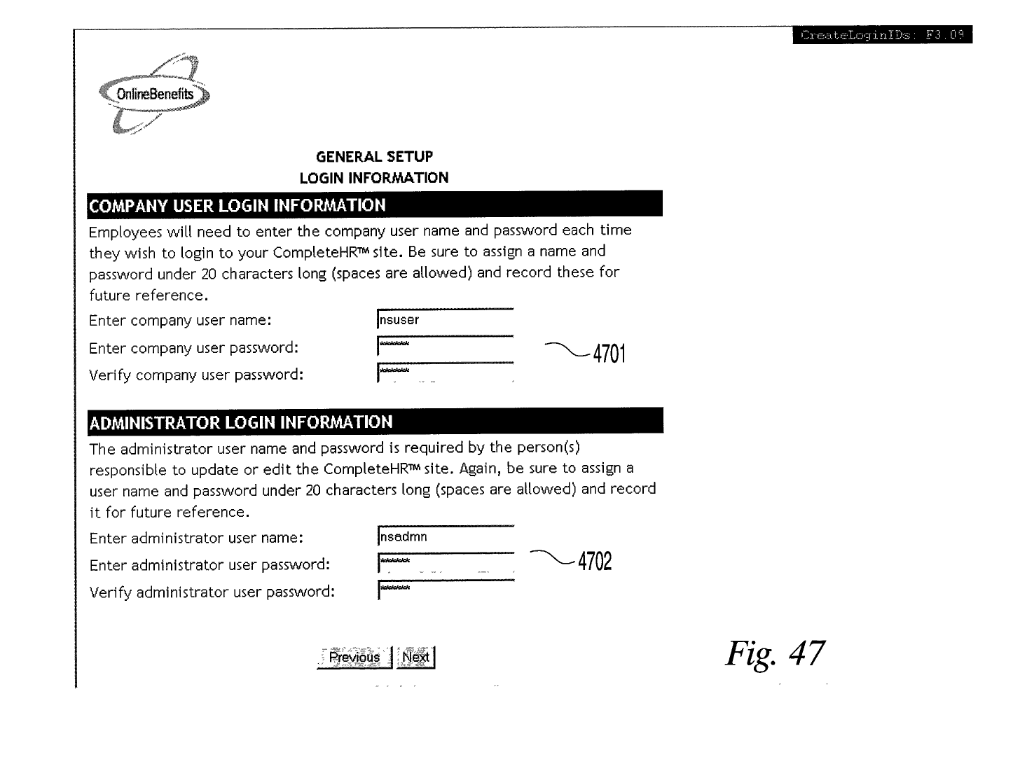

The example preferred system next queries the user to create credentials for users and administrators of the system 1710, as illustrated in FIG. 47. The system requests credentials for employees of the company to use when using the system to retrieve information about the company's benefits plans, and for a Web site administrator who will be responsible for updating and editing the Web site generated by the system 2002. User IDS and passwords are stored in user ID database 328. The user is then given the opportunity to confirm the information entered so far, or to return and reenter or alter the information 1711.

The example preferred system next prompts the user 1712 to update company billing information and company contact information respectively stored in BillingInfo table 503 and CompanyContacts table 504 of company information database 326. The user is also prompted to update broker news information and broker contact information respectively stored in the BrokerNews table 1201 and Broker table 1202 of the broker information database 324.

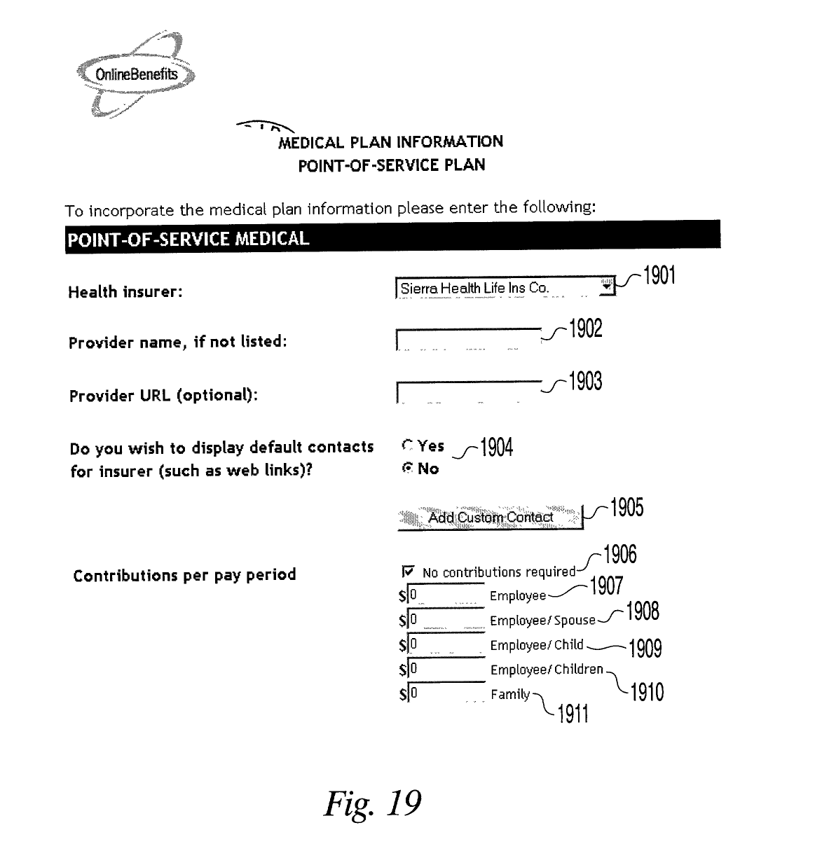

As schematically illustrated in FIG. 18, the user is next prompted by the example preferred system to provide medical benefits plan information for the company. An example preferred medical plan information form for this purpose is illustrated in FIGS. 19-24.

Referring to FIG. 19, health insurers for which information has been entered into the system are prompted for selection in a pull-down menu 1901. If the user's provider does not appear in the pull-down list, the health insurer may be specified by typing in the insurer's name in text box 1902. The health insurer name is used to set or update the Healthinsurer2 field in the Medical table 601 of the benefit plans database 314. A URL for a Web page for the insurer may also be specified in text box 1903, and is used by the system to set or update the HealthlnsurerURL field of Medical table 601. The user is also prompted to specify whether default contacts for the insurer should appear on the Web site to be generated 2503 or to add a custom contact for the company 1905. And the user may specify whether, and if so, how much contribution by an employee is required per pay period for various categories of insured, such as the employee, or the employee and spouse, employee and spouse and one child, etc., using form elements 1906-19111.

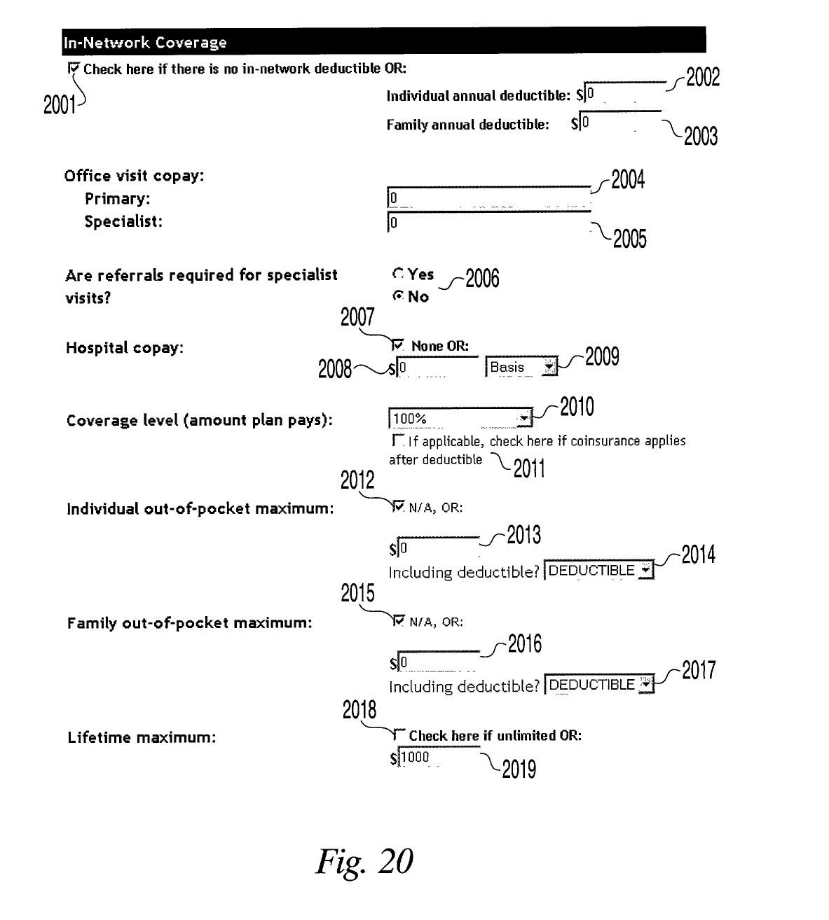

The system prompts the user for information concerning health care insurance coverage within the insurer's provider network using form elements illustrated in FIGS. 20-22. Deductible amounts and copay amounts for primary care physicians and specialists are prompted using form elements 2001-2005. A referral requirement for specialist care is indicated using radio buttons 2006. The amount and basis for copay requirements for hospital visits is indicated using check box, text box and pull-down menu 2007, 2008 and 2009. The level of coverage is prompted using pull-down menu 2010, and the applicability of a deductible to the level of coverage is prompted using check box 2011. The maximum individual out-of-pocket payment, and the applicability of a deductible to this amount is prompted using text box, check box, and pull-down menu 2013, 2012 and 2014, respectively. The maximum family out-of-pocket payment, and the applicability of a deductible to this amount is prompted using text box, check box, and pull-down menu 2016, 2015, and 2017, respectively. A lifetime maximum is prompted using check box 2018 and text box 2019.

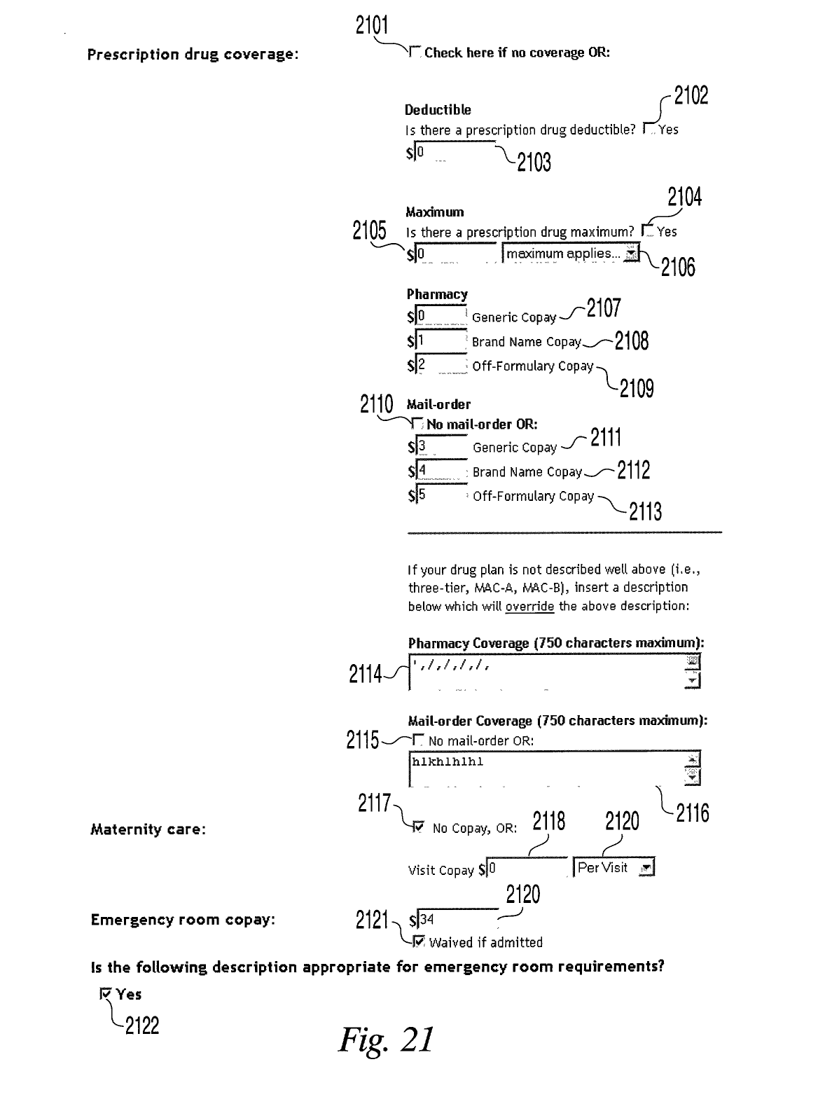

Referring to FIG. 21, prescription drug benefits provided under the plan are prompted using form elements 2101-2116, including applicability of such benefits 2101, deductible 2102, 2103, maximum amount 2104-2106, copay requirements for pharmacy-purchased generic drugs 2107, brand-name drugs 2108 or off-formulary drugs 2109. Similar copay requirements for mail-order-purchased drugs are prompted using form elements 2110-2113. Alternate pharmacy coverage is prompted for using text box 2114, and alternate mail-order coverage is prompted using text box 2116. Maternity care copay information is prompted by the system using form elements 2117-2120. Emergency room copay requirements are prompted using form elements 2120-2121.

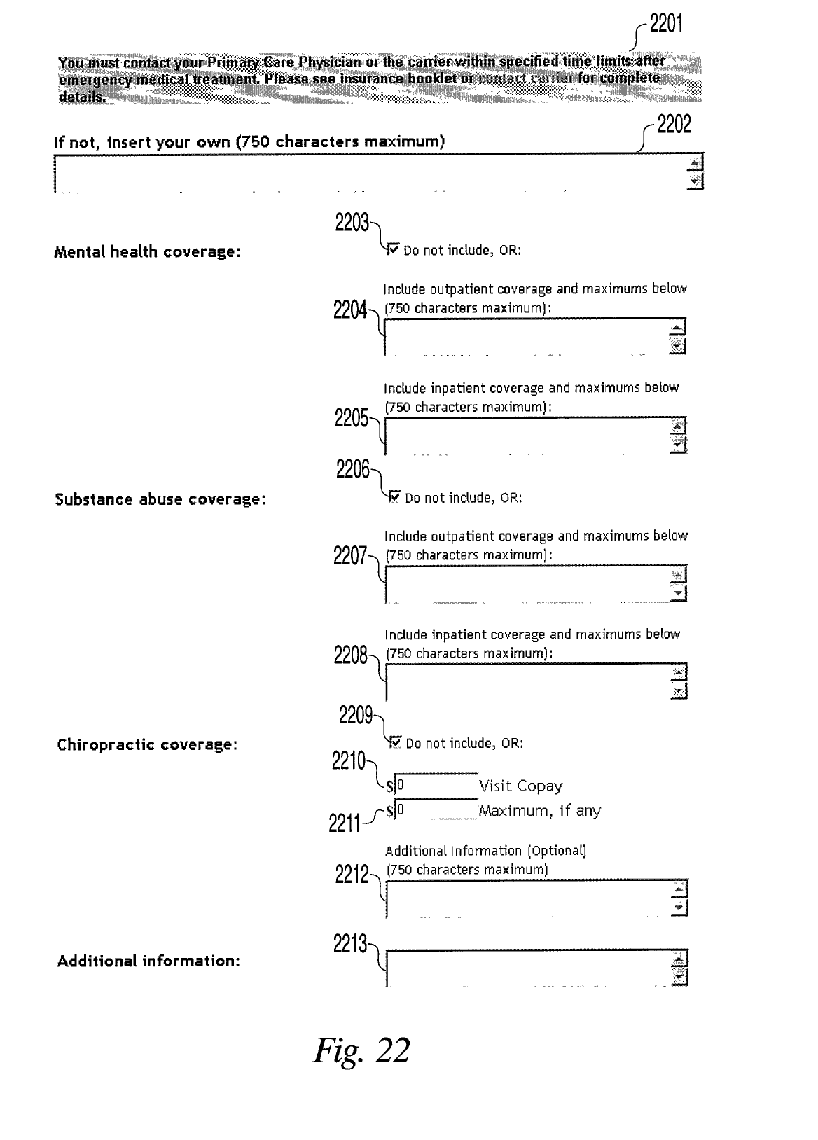

Referring to FIG. 22, the requirements for emergency medical treatment are prompted using form elements 2201, 2202 and check box 2122, shown on FIG. 21. The applicability of mental health coverage and the outpatient and inpatient maximum coverages under the benefits plan are prompted using form elements 2203-2205. The applicability of substance abuse coverage and the outpatient and inpatient maximum coverages under the benefits plan are prompted using form elements 2206-2208. The applicability, copay and maximum chiropractic coverage benefits and additional information regarding chiropractic benefits are prompted using form elements 2209-2212. Additional in-network medical coverage information is prompted using text box 2213.

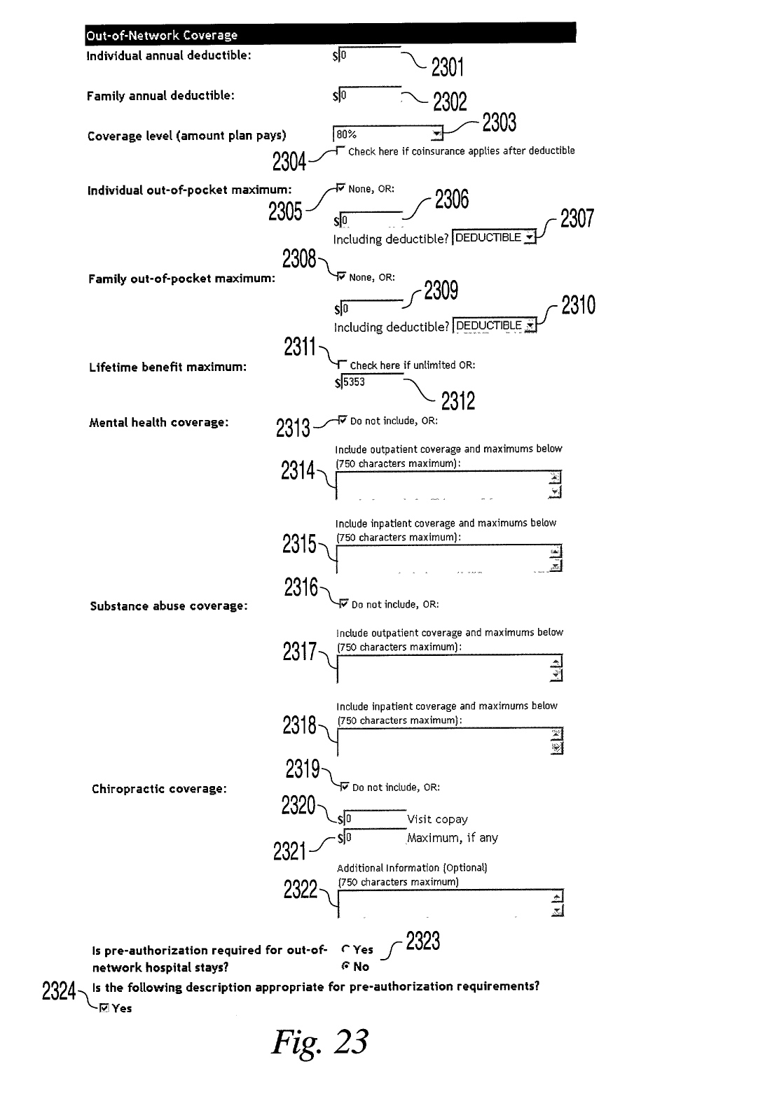

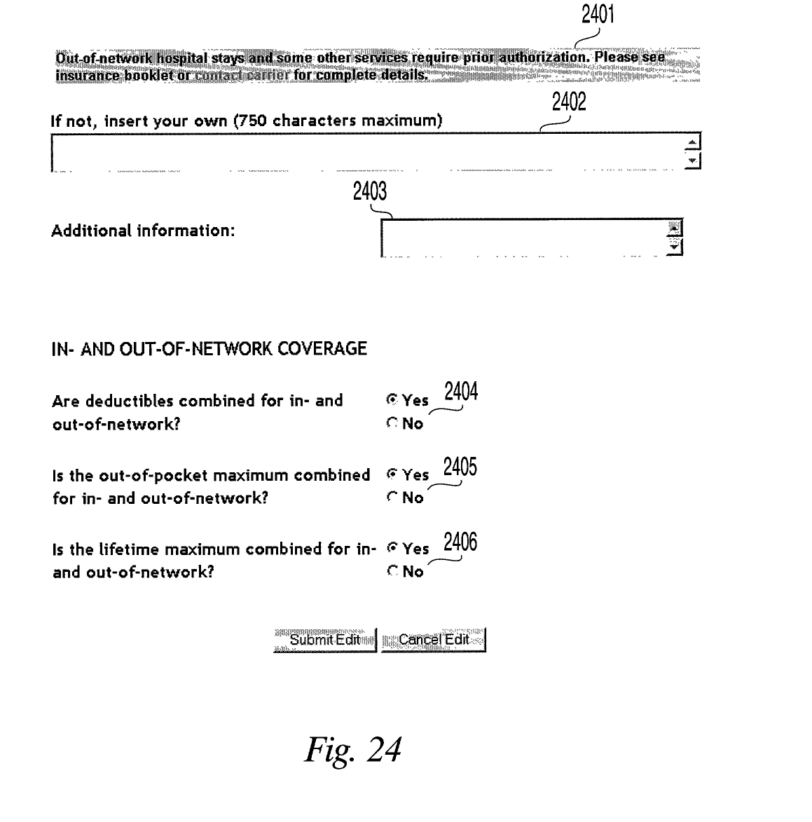

The system prompts the user for information concerning health care insurance coverage outside the insurer's provider network using form elements illustrated in FIGS. 23-24. Individual and family annual deductible amounts are prompted using text boxes 2301 and 2302, respectively. The coverage amount for the plan is indicated using pull-down menu 2303, and the applicability of coinsurance after deductible is prompted using check box 2304. The maximum individual out-of-pocket payment, and the applicability of a deductible to this amount is prompted using text box, check box, and pull-down menu 2306, 2305 and 2307, respectively. The maximum family out-of-pocket payment, and the applicability of a deductible to this amount is prompted using text box, check box, and pull-down menu 2310, 2309, and 2311, respectively. A lifetime maximum is prompted using check box 2311 and text box 2312. The applicability of mental health coverage and the outpatient and inpatient maximum coverages under the benefits plan are prompted using form elements 2213-2315. The applicability of substance abuse coverage and the outpatient and inpatient maximum coverages under the benefits plan are prompted using form elements 2316-2318. The applicability, copay and maximum chiropractic coverage benefits and additional information regarding chiropractic benefits are prompted using form elements 2319-2322. Pre-authorization requirement for hospital stays is prompted using radio buttons 2323.

Referring to FIG. 24, the requirements for emergency medical treatment are prompted using form elements 2401, 2402 and check box 2324, shown on FIG. 23. Additional information concerning out-of network coverage is prompted using text box 2403. Information concerning the applicability of deductibles and maximums to the combination of in-network and out-of-network coverage are prompted using radio buttons 2404, 2405, and 2406.

Returning to FIG. 18, after entering the medical information using the Web form illustrated on FIGS. 19-24, the user is asked to confirm the information. If the user confirms the medical information, the system causes the information to be saved to the Medical table 601 in the benefits plans database 314.

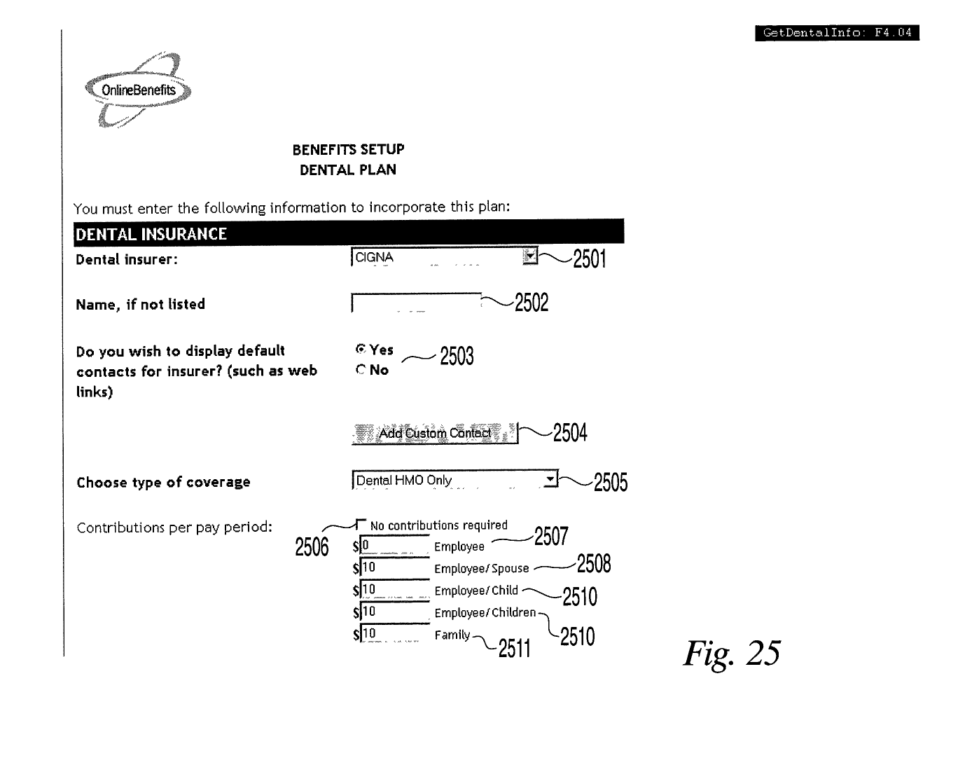

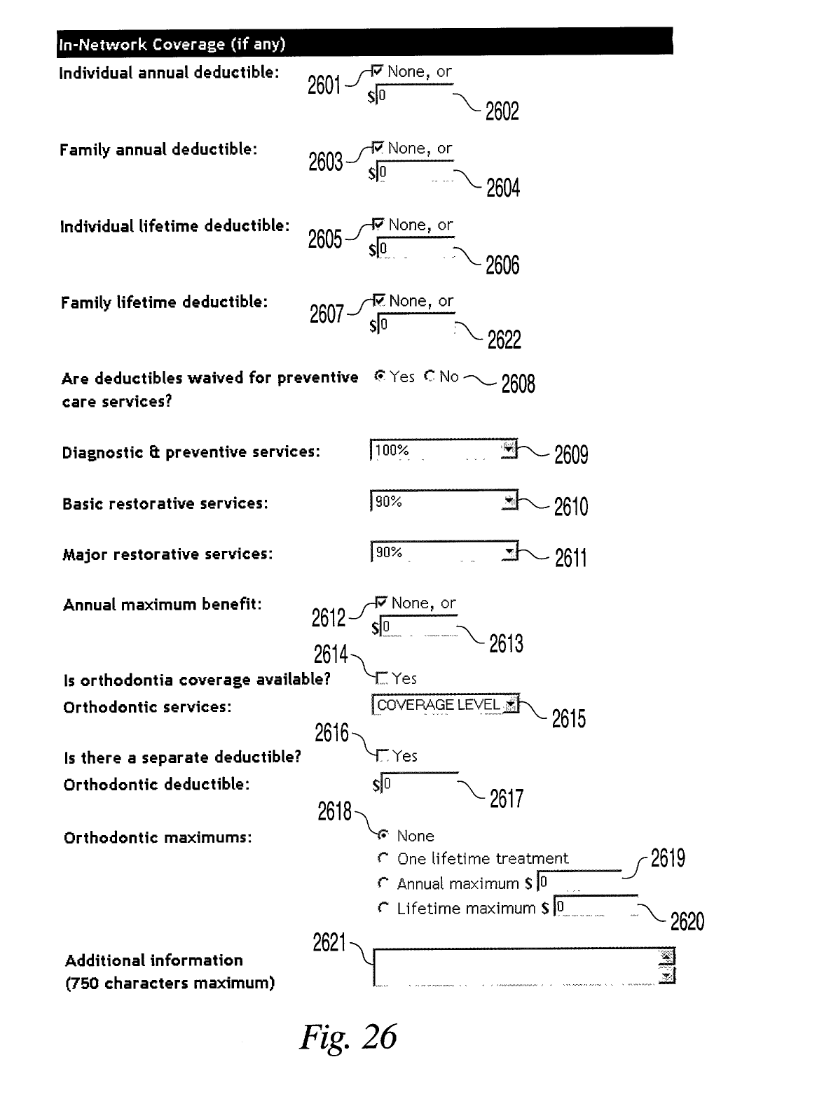

The example preferred system next prompts the user for dental benefits information An example preferred Web form for this is illustrated in FIGS. 25-26. Dental insurers for which information has been entered into the system are prompted for selection in a pull-down menu 2501. If the user's provider does not appear in the pull-down list, the dental insurer may be specified by typing in the name of the insurer in text box 2502. The user is also prompted to specify whether default contacts for the insurer should appear on the Web site to be generated 2503 or to add a custom contact for the company 2504. And the user may specify whether, and if so, and how much contribution by an employee is required per pay period for various categories of insured, such as the employee, or the employee and spouse, employee and spouse and one child, etc., using form elements 2506-2511.

The system prompts the user for information concerning dental care insurance coverage within the insurer's provider network using form elements illustrated in FIG. 26. Individual and family annual deductibles are prompted using form elements 2601-2604. Individual and family lifetime deductibles are indicated using form elements 2605-2608 and 2622. The level of coverage for diagnostic and preventative services, basic restorative services and major restorative services are prompted using pull-down menus 2609-2611. The applicability and amount of an annual maximum benefit amount is prompted using check box and text box 2613. The applicability and coverage level of orthodontia coverage is prompted using check box and pull-down menu 2614, 26155. The applicability and amount of a separate orthodontia deductible is prompted using check box and text box 2616 and 2617. Orthodontic maximums are prompted using radio buttons 2618 and text boxes 2619, 2620. Additional information concerning in-network dental coverage is prompted using text box 2621.

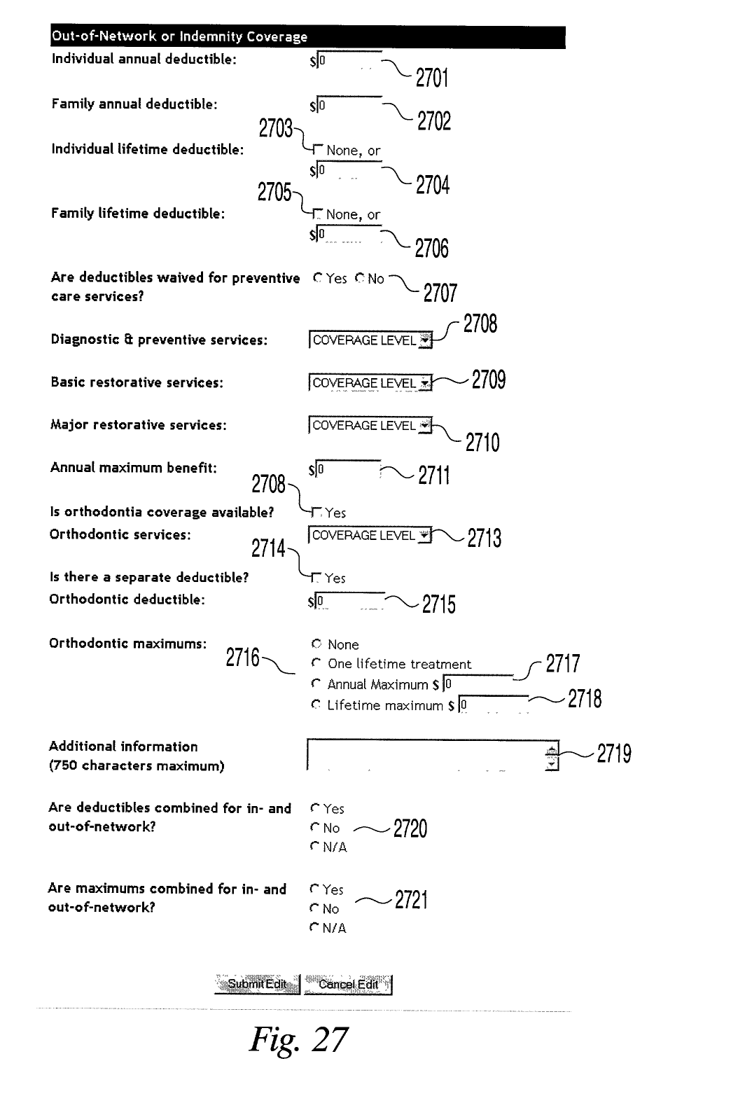

The system prompts the user for information concerning dental care insurance coverage outside the insurer's provider network using form elements illustrated in FIG. 27. Individual and family annual deductibles are prompted using form elements 2701-2702. Individual and family lifetime deductibles are indicated using form elements 2703-2705. The level of coverage for diagnostic and preventative services, basic restorative services and major restorative services are prompted using pull-down menus 2708-2710. The annual maximum benefit is prompted using text box 2711. The applicability and coverage level of orthodontia coverage is prompted using check box and pull-down menu 2712-2713. The applicability and amount of a separate orthodontia deductible is prompted using check box 2714 and text box 2715. Orthodontic maximums are prompted using radio buttons 2716 and text boxes 2717, 2718. Additional information concerning in-network dental coverage is prompted using text box 2719. Information concerning the applicability of deductibles and maximums to a combination of in-network and out-of-network dental services is prompted using radio buttons 2720 and 2721.

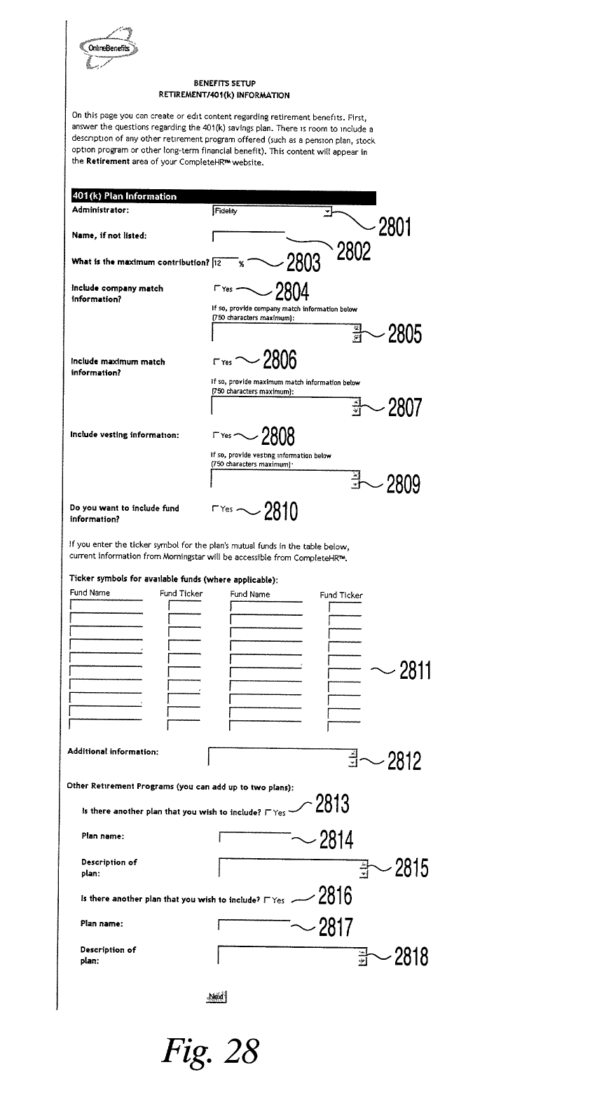

Returning to FIG. 18, after receiving the prompted dental information, the system prompts the user to confirm the information. If confirmed, the system causes the information to be stored 1805 in the Dental table 701 of the benefits plans database 314. After storing the dental information 1805, the system prompts the user for other benefits information 1806, as illustrated in FIGS. 28-30.

The example preferred system prompts the user for retirement/401(k) benefits information using the form illustrated in FIG. 28. Plan administrators for which information has been entered into the system are prompted for selection in a pull-down menu 2801. If the user's plan administrator does not appear in the pull-down list, the plan administrator may be specified by typing in the name in text box 2802. The maximum employee contribution is indicated using text box 2803. The applicability of a company matching contribution is prompted using check box 2804, and related information is prompted using text box 2805. The applicability of a maximum company matching contribution is prompted using check box 2806, and related information is prompted using text box 2807. The applicability of vesting information is prompted using check box 2808, and related information is prompted using text box 2809. The user is prompted as to whether to include mutual fund information using text box 2810. Information concerning such funds is prompted using text boxes for fund name and ticker 2811. Additional information is prompted using text box 2812.

In the example preferred embodiment, up to two additional plans may be specified using form elements 2813-2818 for indicating whether such a plan should be included, the plan name and a description of the plan.

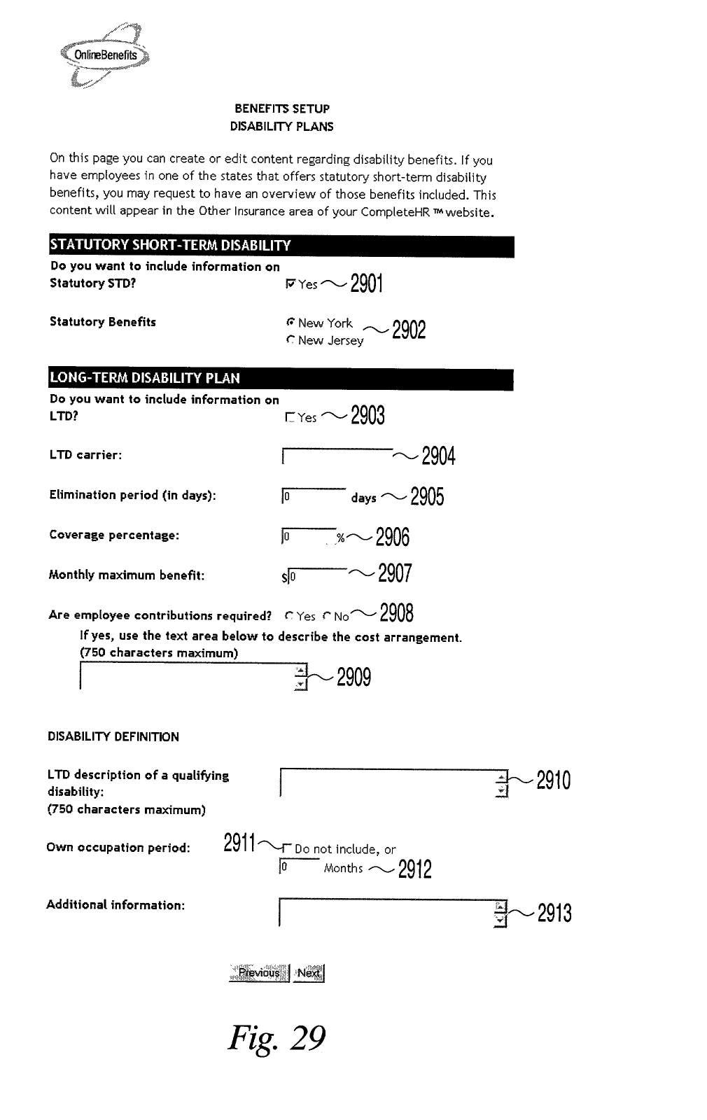

The user is prompted for disability plan information in the example preferred embodiment using the form illustrated in FIG. 29. The applicability of statutory short-term disability benefits is prompted using check box 2901, and the applicable state is prompted using radio buttons 2902. The applicability of long-term disability benefits is prompted using check box 2903, and the carrier for such benefits coverage is prompted using text box 2904. The elimination period for long-term disability benefits is prompted using text box 2905, and the percentage of the employee's salary covered is prompted using text box 2906. The monthly maximum benefit is prompted using text box 2907. The applicability and arrangement regarding employee contributions to long-term disability benefits are prompted using radio buttons 2908 and text box 2902. The definition of a qualifying disability is prompted using text box 2910. The applicability and length of an “own occupation” period are prompted using check box 2911 and text box 2912. Additional information is prompted using text box 2913.

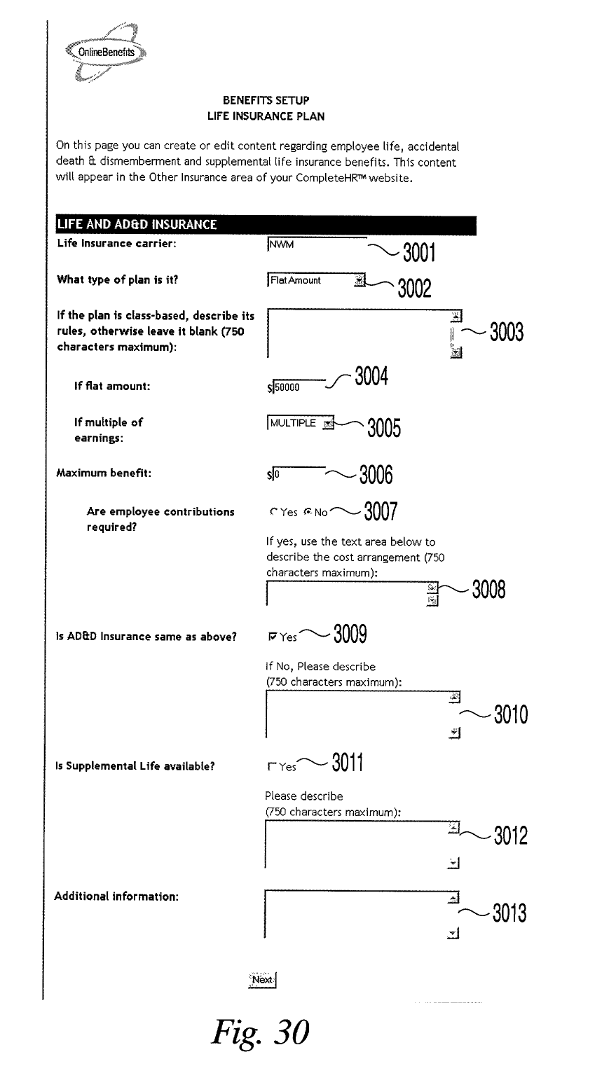

The user is prompted for life insurance benefits information using the form illustrated in FIG. 30. Carriers for which information has been entered into the system are prompted for selection in a pull-down menu 2801. If the user's plan carrier does not appear in the pull-down list, the carrier may be specified by typing in the name in text box 2802. The type of plan is prompted using pull-down menu 3002. Rules for a class-based system are prompted using text box 3003. The user is prompted to specify a flat amount if the coverage is for a flat amount using text box 3004, and multiple earnings using pull-down menu 3005. A maximum benefit is prompted using text box 3006, and the applicability and cost arrangement of employee contributions are prompted using radio buttons 3007 and text box 3008. The user is prompted to specify whether the life insurance benefit already specified is the same as AD&D insurance, and if no, to describe, using check box 3009 and text box 3010. The availability and description of supplemental life insurance is prompted using check box 3011 and text box 3012. The user is prompted for additional information using text box 3013.

Returning to FIG. 18, after receiving the prompted other benefits information 1806, the system prompts the user to confirm the information 1807. If confirmed, the system causes the information to be stored 1808 in the Company table 501 of the company information database 326. After storing the other benefits information 1808, the system moves to a generic forms step 1809. The forms setup form is illustrated in FIG. 16 as discussed above.

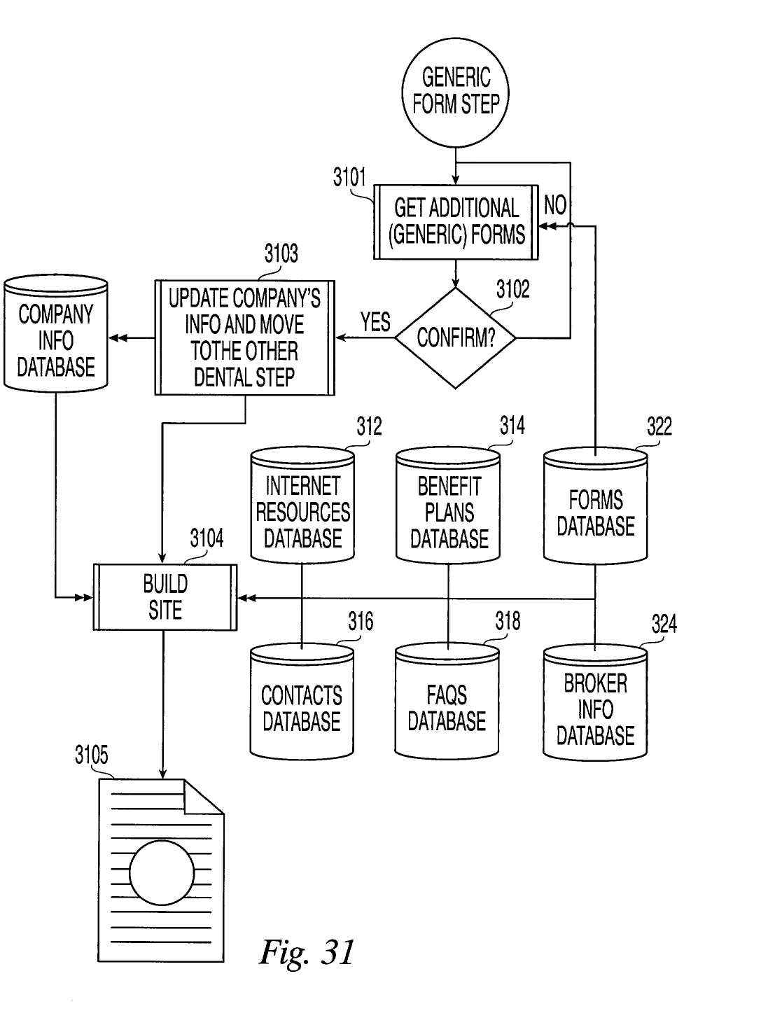

Referring now to FIG. 31, after prompting the user to select additional generic forms, the system prompts the user to confirm the information 3102. If confirmed, the system causes the information to be stored 3103 in the Company table 501 of the company information database 326. After storing the generic forms information 3103, the system builds 3104 a human resources Web site 3105 using the information stored in the databases 310-328.

The system builds a human resources Web site by querying the Web resources database 312, benefits plans database 314, forms database 322, contacts database 316, frequently-asked questions database 318, and broker information database 324 for the data needed to populate HTML templates for a human resources communication Web site.

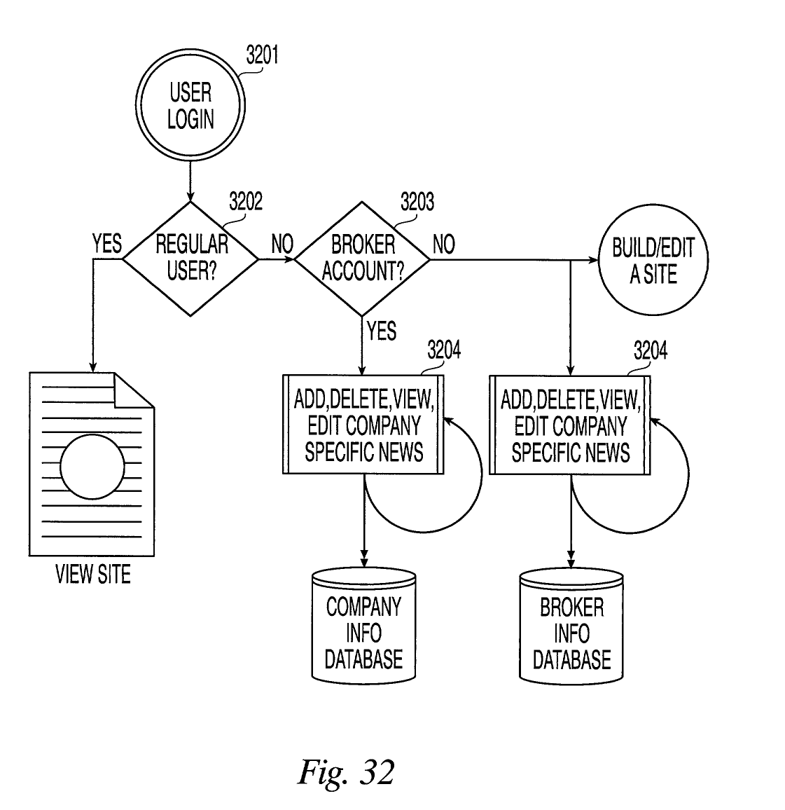

Use of the human resources Web site is schematically illustrated in FIG. 32. A user logs in 3201, and the system authenticates the user against credentials stored in the user ID database 328. Based on the credentials, the system determines whether the user is a regular user 3202, broker 3303, or developer and presents the user with the appropriate welcome page.

If the user is a regular user, the system determines the company that employs the user based on the user ID database 328. An example preferred welcome page for a regular user is shown in FIG. 33. The CompanyName field from Company table 501 is used to insert the company name into a template for the welcome page, causing the company name to appear in the title 3201 and in the welcome paragraph 3302. Similarly, the name of the brokerage firm that created the page is retrieved from the Broker_firm field of the Broker table 1202 and inserted into the sponsor line 3303. A navigation bar 3304 is included on every page, with links to various information pages available on the site.

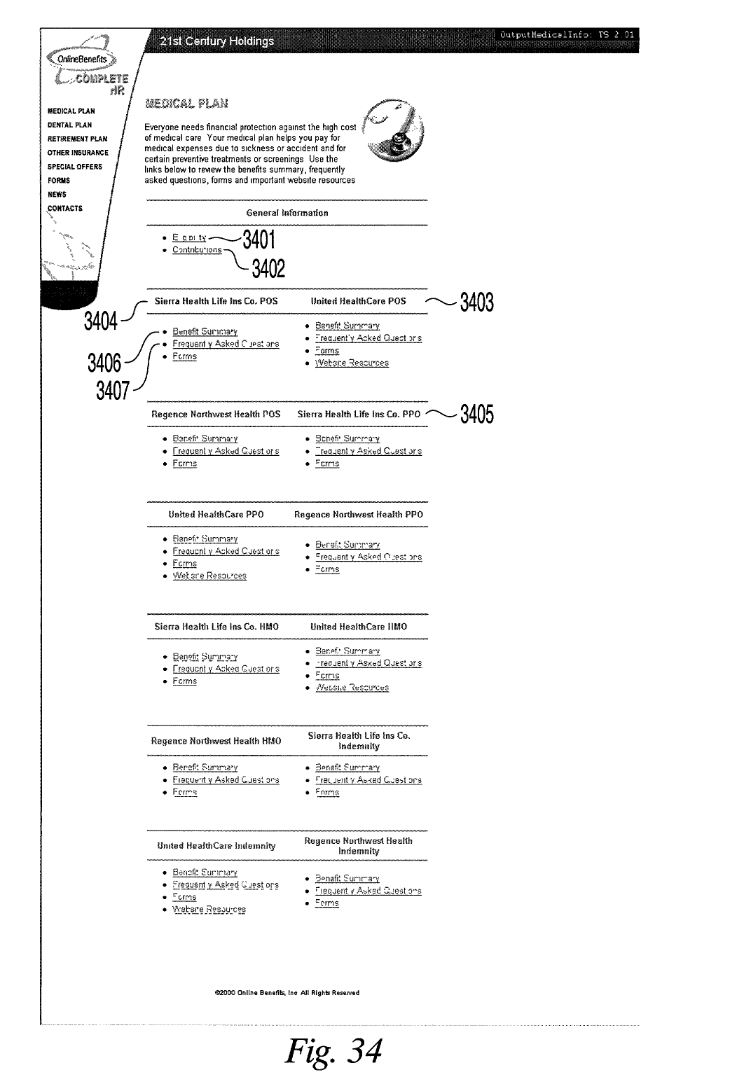

The medical plan link on the navigation bar 3304 on the welcome page shown in FIG. 33, is linked by HTML hyperlink to the medical plan information page shown in FIG. 34. Eligibility information may be retrieved by selecting the Eligibility link 3401, and contribution information may be retrieved by selecting Contribution link 3402. Each health benefit plan offered to employees of the user's company is represented by a collection of links on the medical plan information page. For example, the point-of-service (POS) benefits plan offered by Sierra Health Life Insurance Company is represented by the collection of links at 3404 and the preferred-provider-organization (PPO) benefits plan offered by Sierra Health Life Insurance Company is represented by the collection of links at 3405.

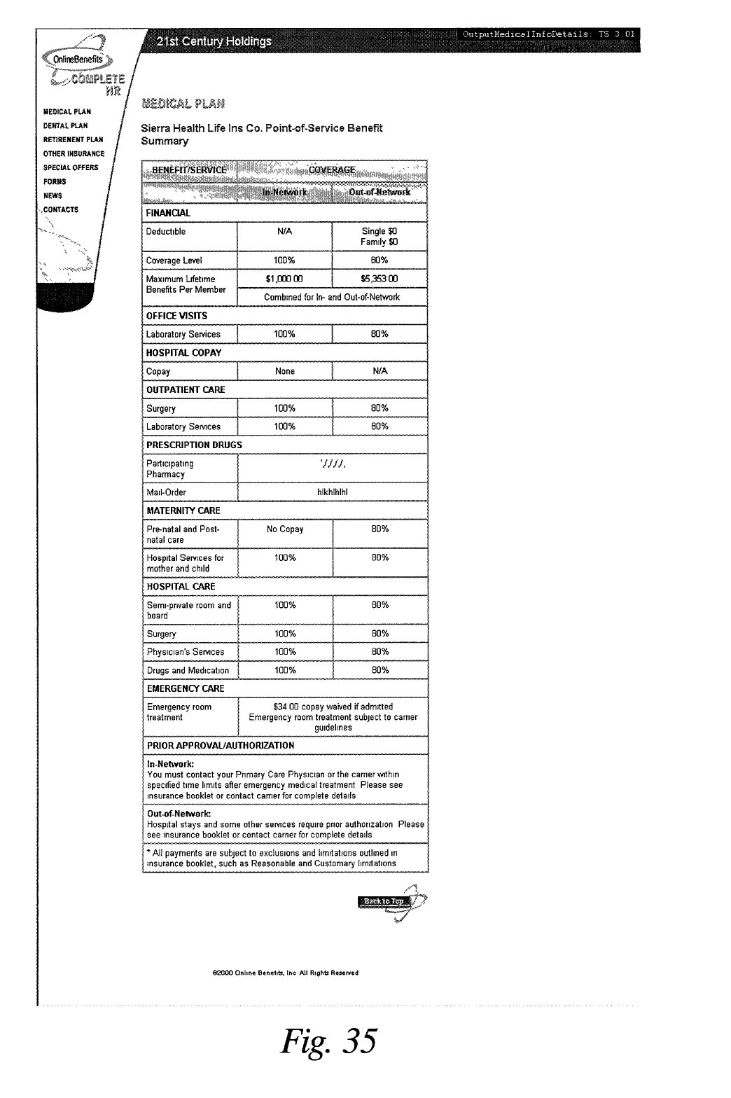

Benefits summary links such as 3406 are linked to benefits summary pages, such as the example illustrated in FIG. 35. The system generates benefits summary pages for each plan by querying the benefits plans database 314 and populating a medical plan benefits summary page template with data retrieved from the Medical table 601, Health table 602 and HealthPlan table 603 of the benefits plans database 314.

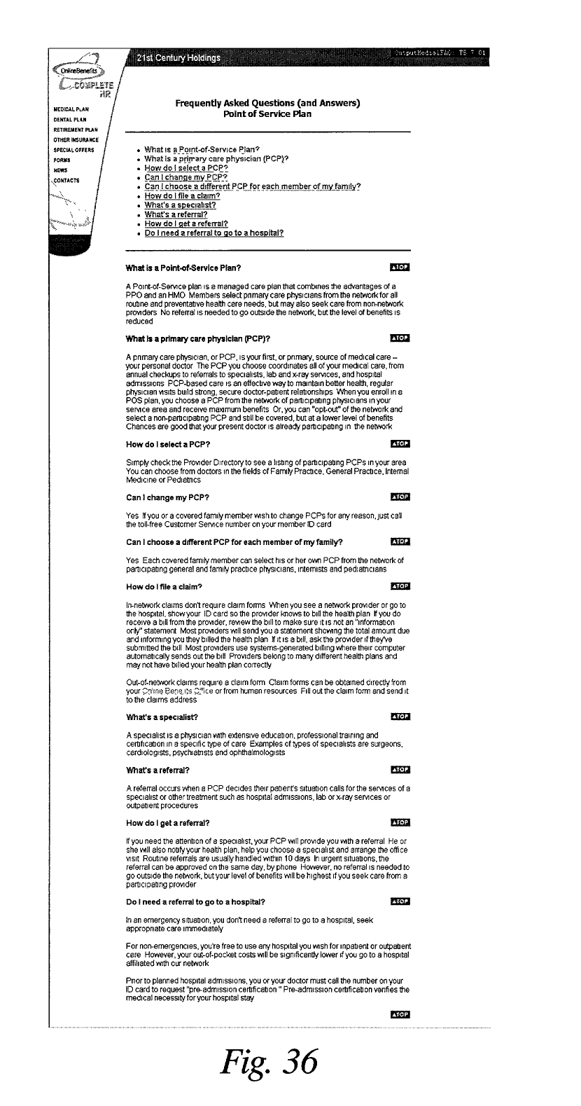

Frequently Asked Questions links such as 2406 are linked to Frequently Asked Questions pages such as the example illustrated in FIG. 36. When the medical plan information page illustrated in FIG. 34 is generated, the system determines the Uniform Resource Locator (URL) for the link from the FAQFilename field of the MedicalFAQ table of the Frequently Asked Questions Database 318.

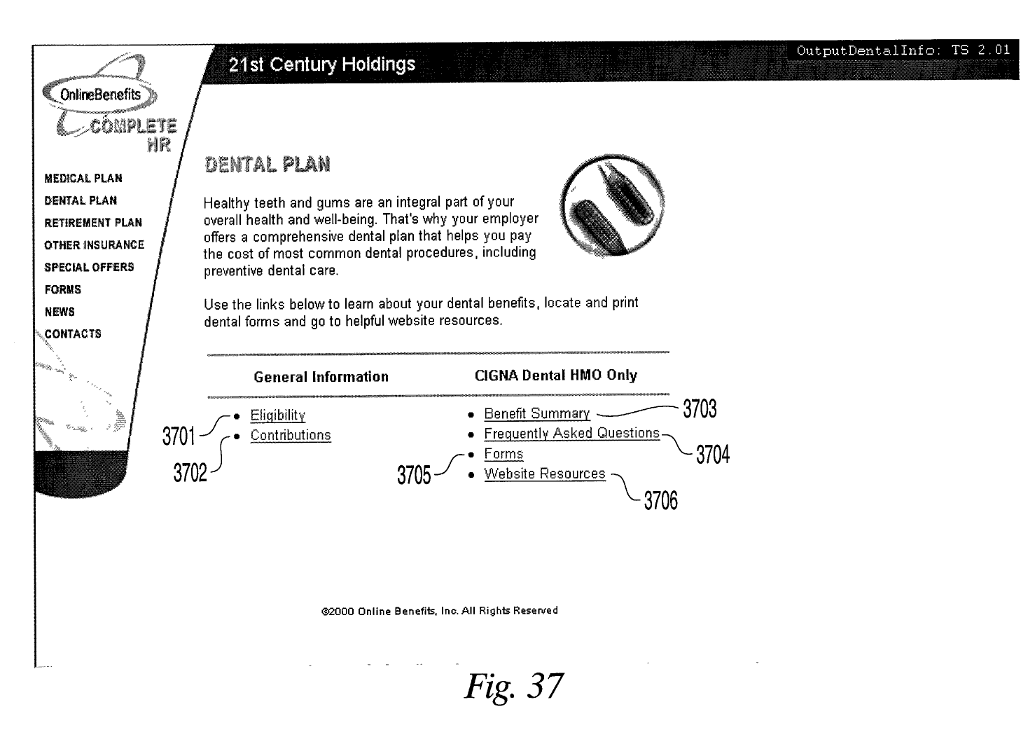

The dental plan link on the navigation bar 3304 on the welcome page shown in FIG. 33 is linked by HTML hyperlink to the dental plan information page shown in FIG. 37. Eligibility information may be retrieved by selecting the Eligibility link 3401, and contribution information may be retrieved by selecting Contribution link 3402. Each dental benefit plan offered to employees of the user's company is represented by a collection of links on the dental plan information page. In this example, only the CIGNA Dental HMO plan is offered by the user's employer.

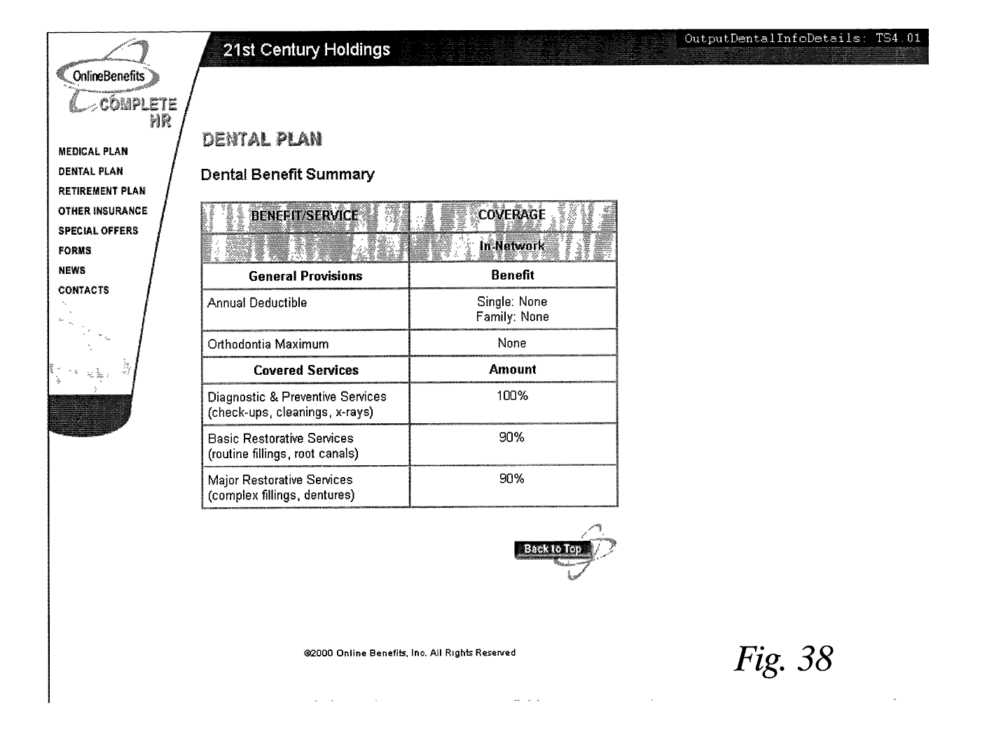

Benefits summary links such as 3703 are linked to benefits summary pages, such as the example illustrated in FIG. 38. The system generates benefits summary pages for each plan by querying the benefits plans database 314 and populating a dental plan benefits summary page template with data retrieved from the Dental table 701, Dental table 802 and DentalPlan table 903 of the benefits plans database 314.

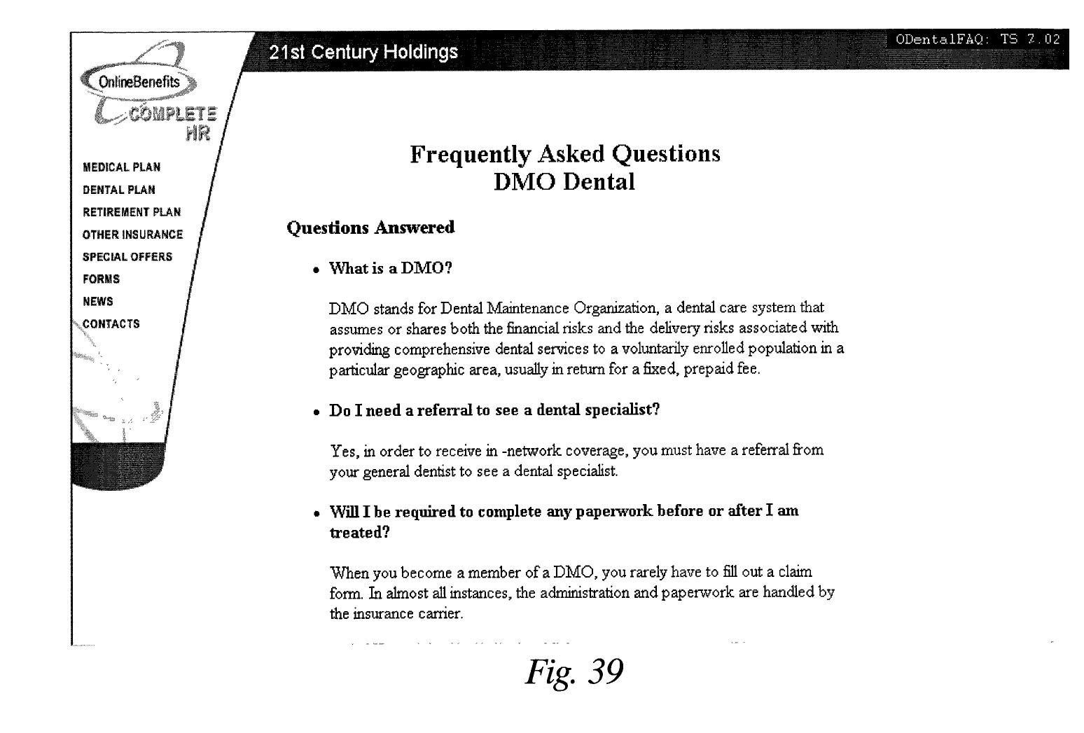

Frequently Asked Questions links such as 3704 are linked to Frequently Asked Questions pages such as the example illustrated in FIG. 39. When the dental plan information page illustrated in FIG. 37 is generated, the system determines the Uniform Resource Locator (URL) for the link from the FAQFilename field of the MedicalFAQ table of the Frequently Asked Questions Database 318.

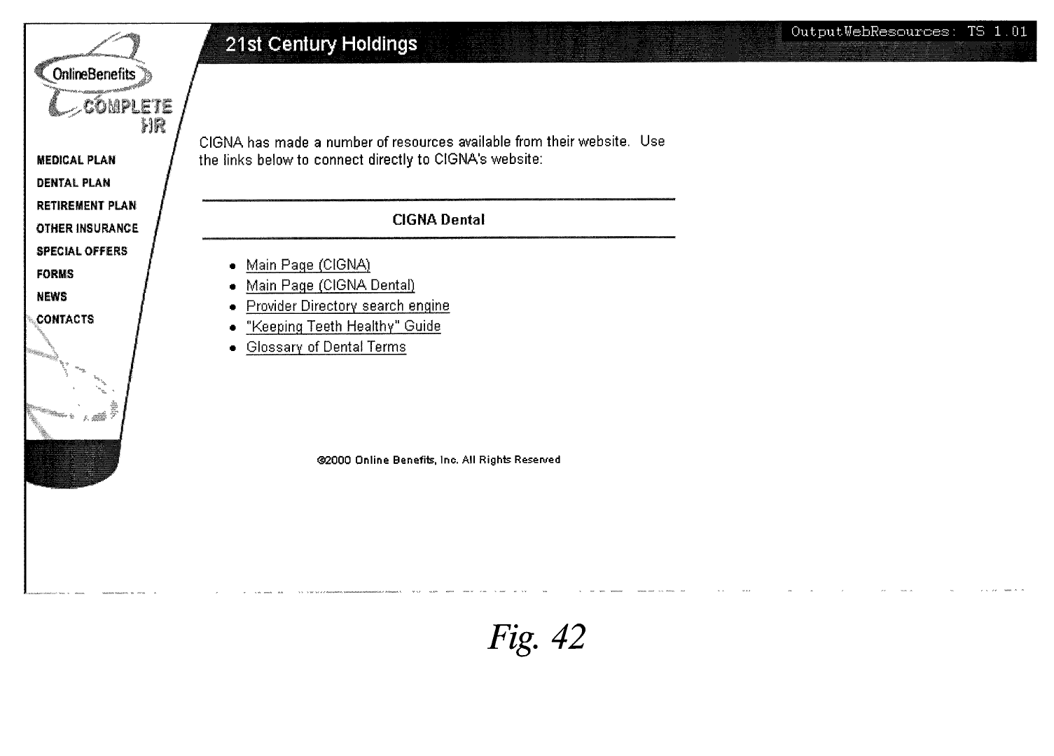

Website resources links such as 3706 are linked to a page containing links to other Web pages of interest related to the dental plan, such as the example Website resources page illustrated in FIG. 42. Website resource pages such as that illustrated in FIG. 42 are generated by querying WebsiteResource table 401 of Web resources database 312 and populating a Web resources page template with URLs determined from the URLFileName field.

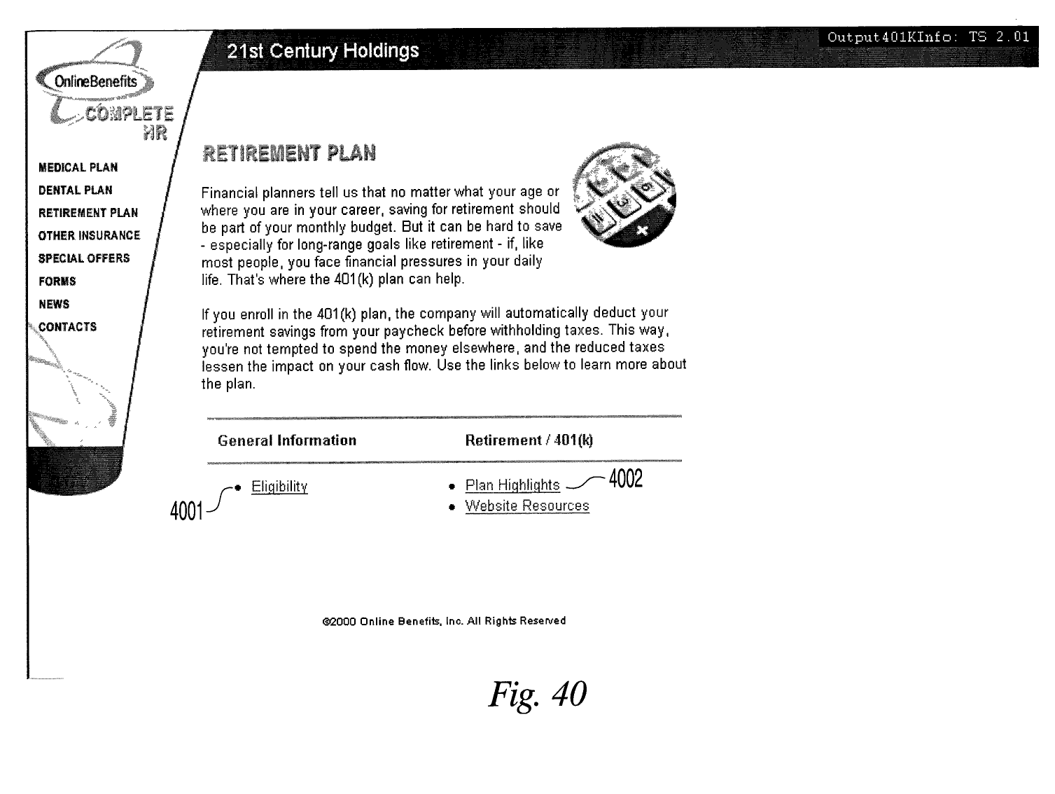

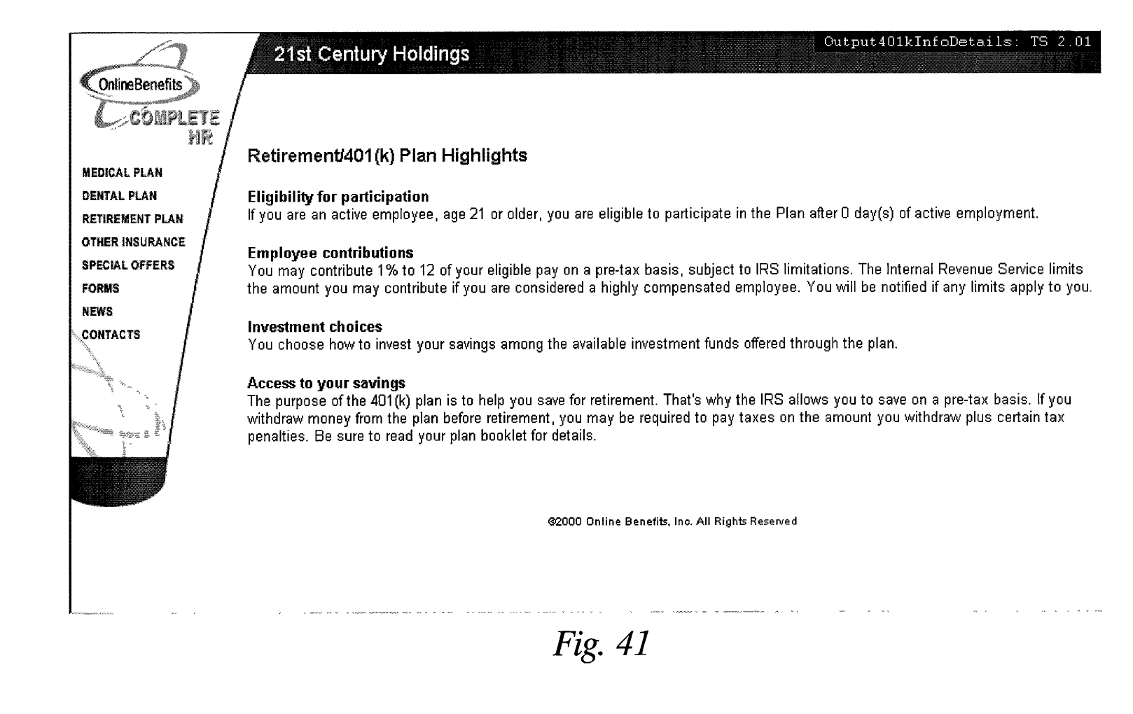

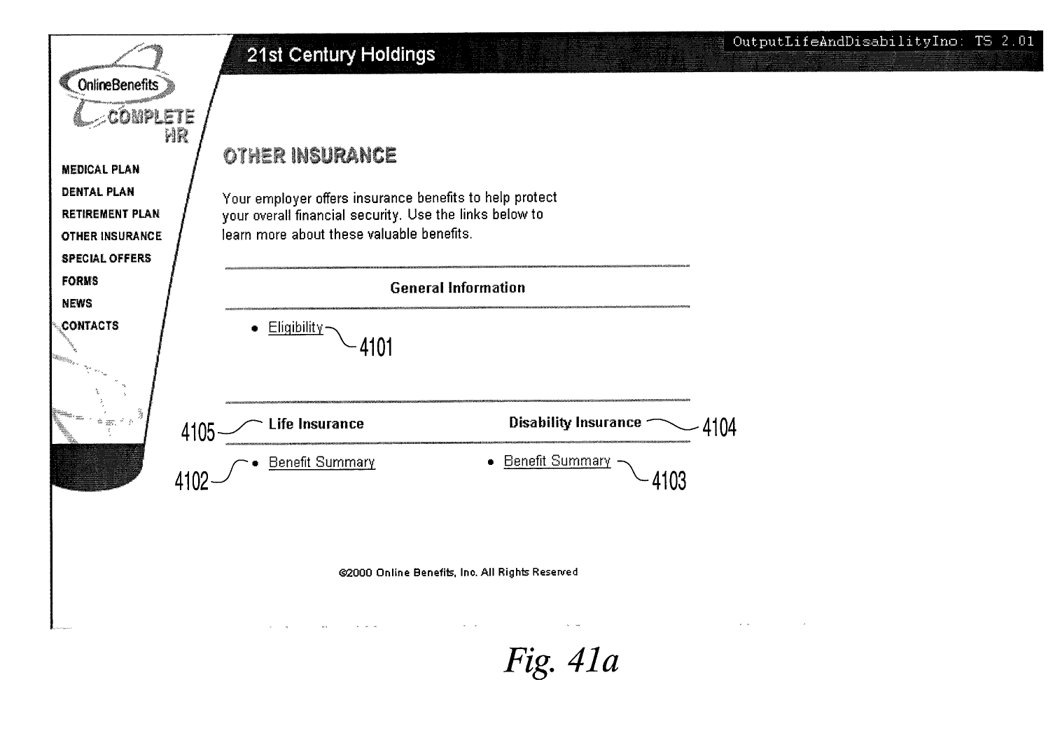

The retirement plan link on the navigation bar 3304 on the welcome page shown in FIG. 33 is linked to a retirement plan information page, exemplified by the page shown in FIG. 40. Eligibility information may be retrieved by selecting the Eligibility link 4001. The Plan Highlights link is linked to a plan highlights page, exemplified by the page shown in FIG. 41. The plan highlights page is generated from a plan highlights template page using information retrieved from the Company table 501 of the company information database 326.

The other insurance link on the navigation bar 3304 is linked to an other insurance information page, exemplified by the page shown in FIG. 41a. Eligibility information may be retrieved by selecting the Eligibility link 4101. For each form of other insurance other than health and dental available to employees, a collection of links is presented. In this example, disability insurance 4104 and life insurance 4105 are made available. Benefits summary information page links are provided for each.

The special offers link on the navigation bar 3304 is linked to a special offers page containing information about special purchasing opportunities for goods or services that are available to the user.

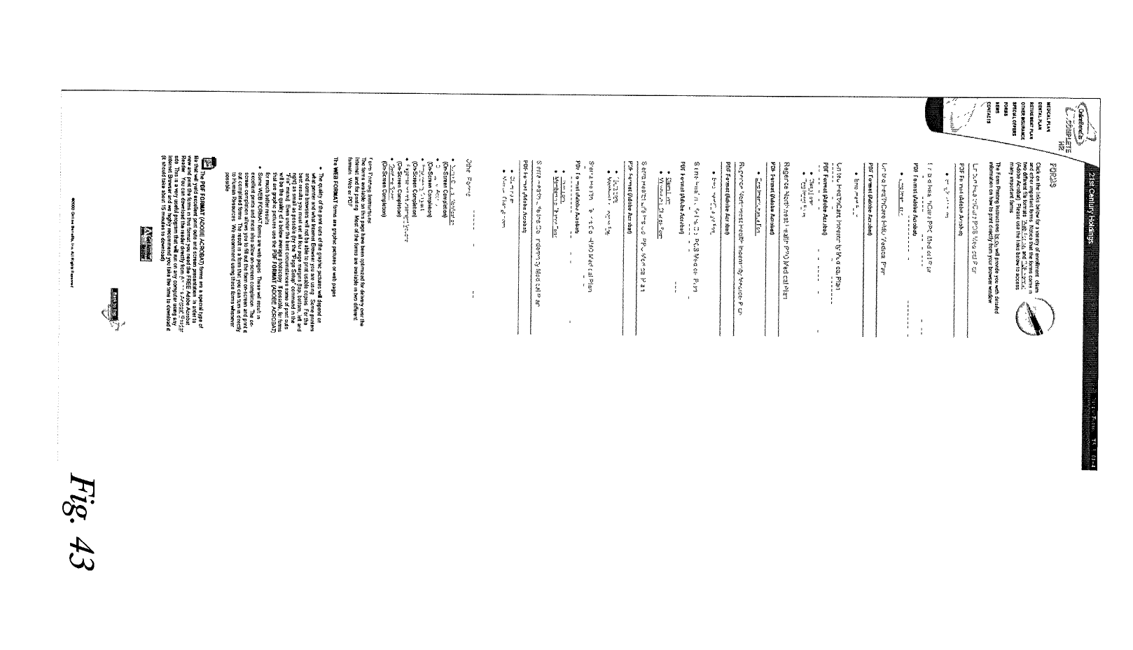

The forms link on the navigation bar 3304 is linked to a forms page containing links to forms needed for claims processing and other benefits administration tasks. An example forms page is illustrated in FIG. 43. A group of links is provided on the form page for every medical benefits plan available through the user's employer, as well as any other benefits plans for which forms are required, and to forms that are used in administration of all benefits plans. Forms are preferably provided either for on-screen completion or in Adobe portable document format. The forms page is generated by querying MedicalForms table 1101, DentalForms table 1102, GeneralForms table 1103 and GeneralForms_Part table 1104 and populating a forms page template with retrieved information.

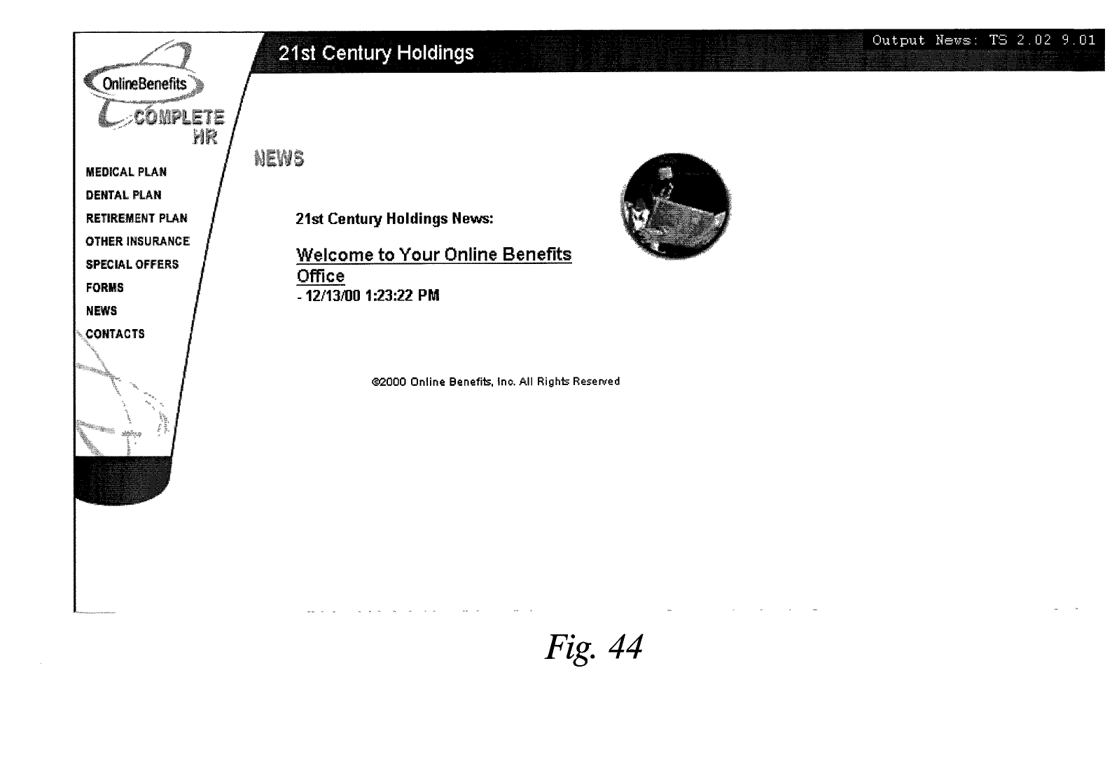

The news link on the navigation bar 3304 is linked to a news page for news about the user's employer and the employer's broker. An example news page is illustrated in FIG. 44. The news page is generated by querying BrokerNews table 1201 of the broker information database 324 and CompanyNews table 502 of the company information database 326 and populating a forms page template with the retrieved information.

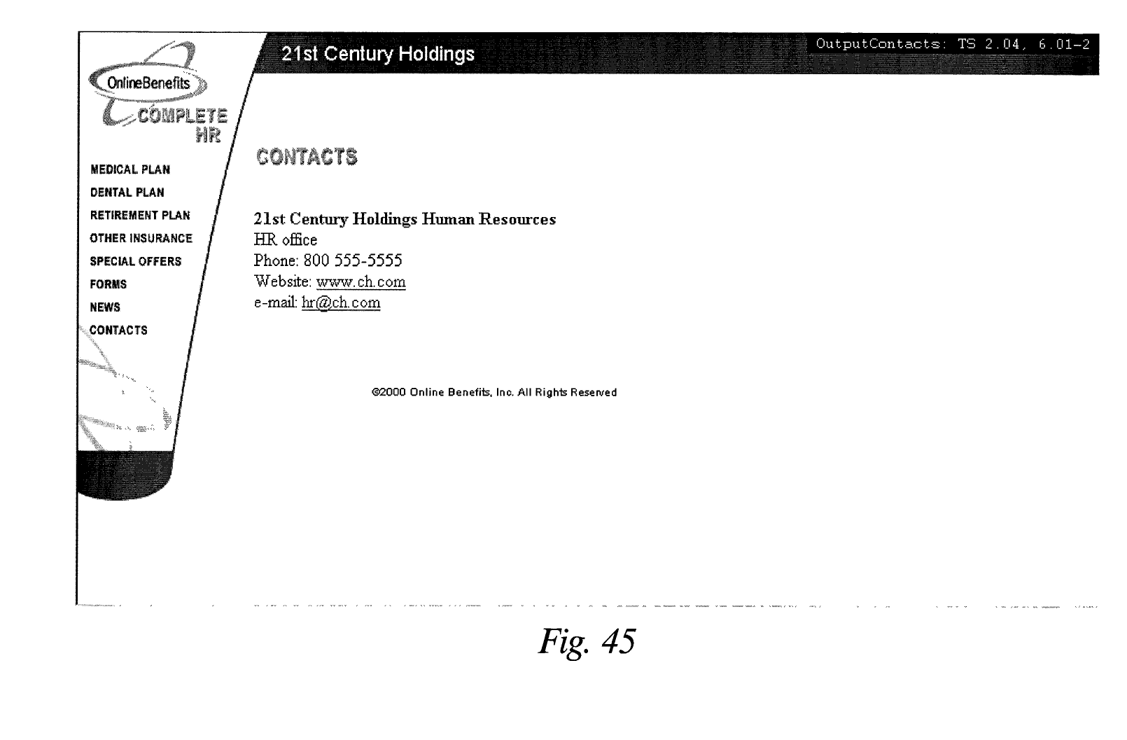

The contacts link on the navigation bar 3304 is linked to a contacts page for the user's employer, containing contact information for administrators or others responsible for the benefits plans available through the company. An example contacts page is illustrated in FIG. 45. The contact page is generated by querying the CompanyContacts table 504 of the company information database 326 and the MedicalContacts table 901 and the DentalContacts table 902 of the contacts database 316 and populating a contacts page template with the retrieved information.

A second preferred embodiment comprises a different architecture and different database schema from the preferred embodiment described above. This second preferred embodiment comprises a database schema as illustrated in Appendix 1. In this preferred embodiment, some tables of the embodiment described above have been abstracted into more general tables. For example, the MedicalFAQ and DentalFAQ tables of the Frequently Asked Questions Database 308 have been replaced with a FAQs table. The FAQs table contains questions and answers stored as text in the database, rather than pointers to HTML files containing complete FAQs. In addition, the MedicalForm and DentalForm tables of the Forms Database 322 have been replaced with a Forms table for both medical and dental forms.

In this second preferred embodiment, an XML instance is created for each site at the time information for that site is input or updated. Each XML instance comprises an XML encoding the data in the record or records in each table described in Appendix 1 having a siteID for the site corresponding to that instance.

The XML instance for a site is transformed into an HTML representation for display by the user at the time that a user views the site with an XSLT processor. In this second preferred embodiment, the Web Application Layer 333 preferably includes an XSLT processor, such as Microsoft MSXML 4.0. This XSLT processor, or an XSLT processor resident in the user's browser, accesses XSLT files stored on the system (either through the local file system or via Web server 332), and transform the XML instance in accordance with the XSLT files. Deployment of XSLT and XML in conjunction with Microsoft's IS Web server system is described in XSLT Developer's Guide, available from the Microsoft Developer Network, which is incorporated herein in its entirety by reference.

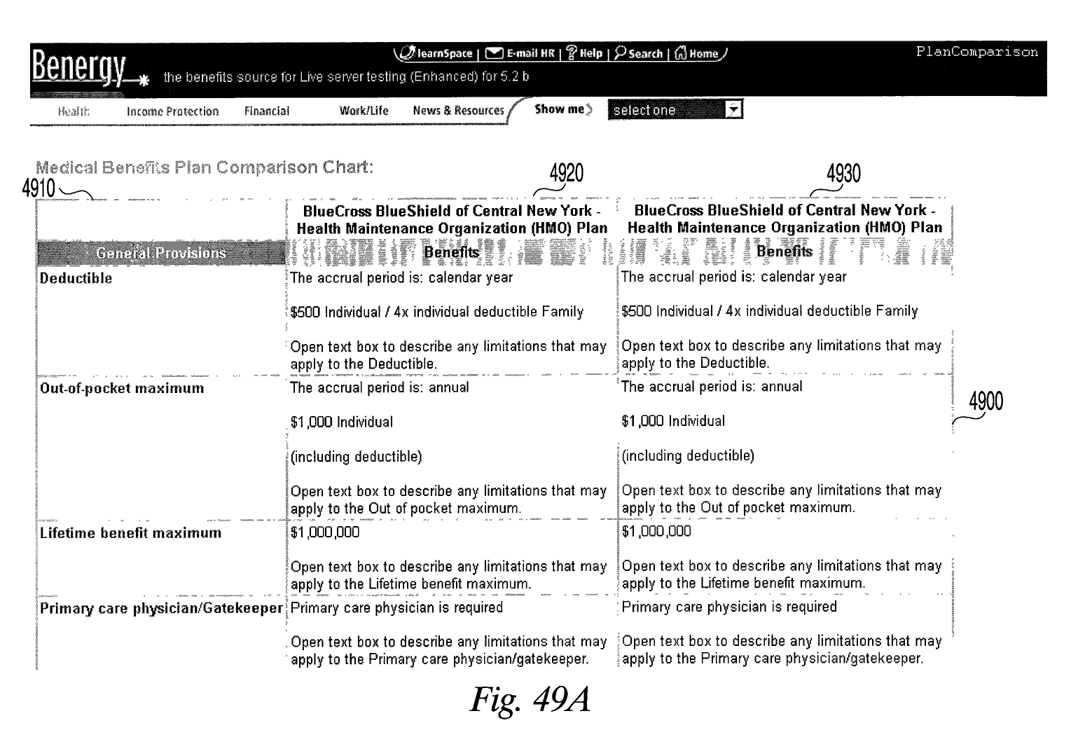

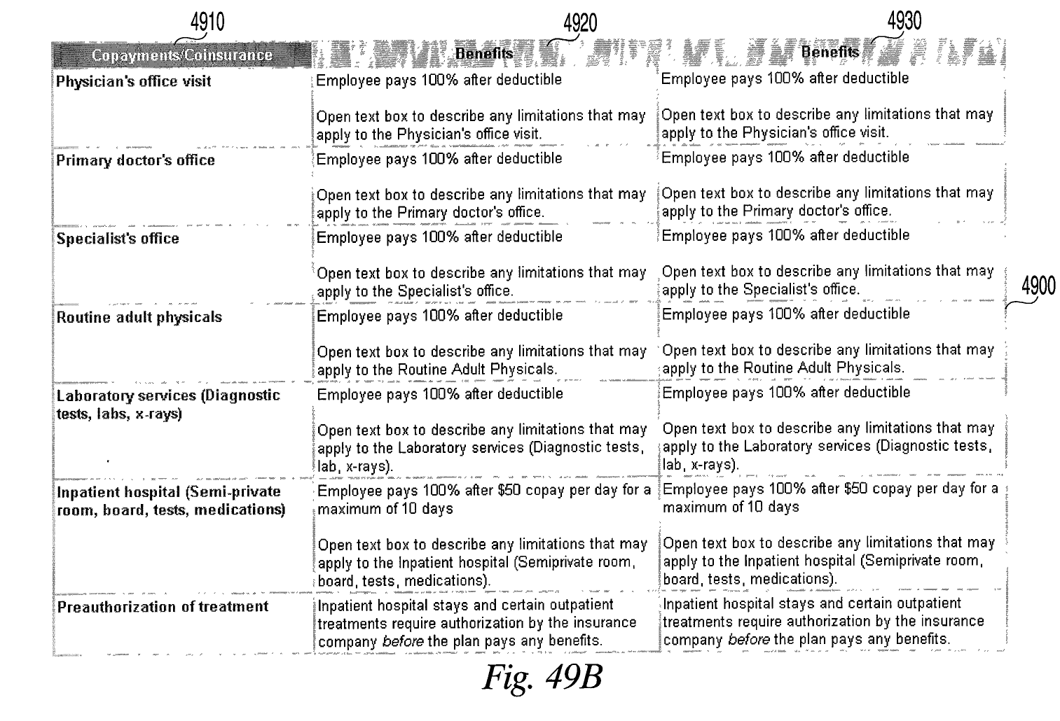

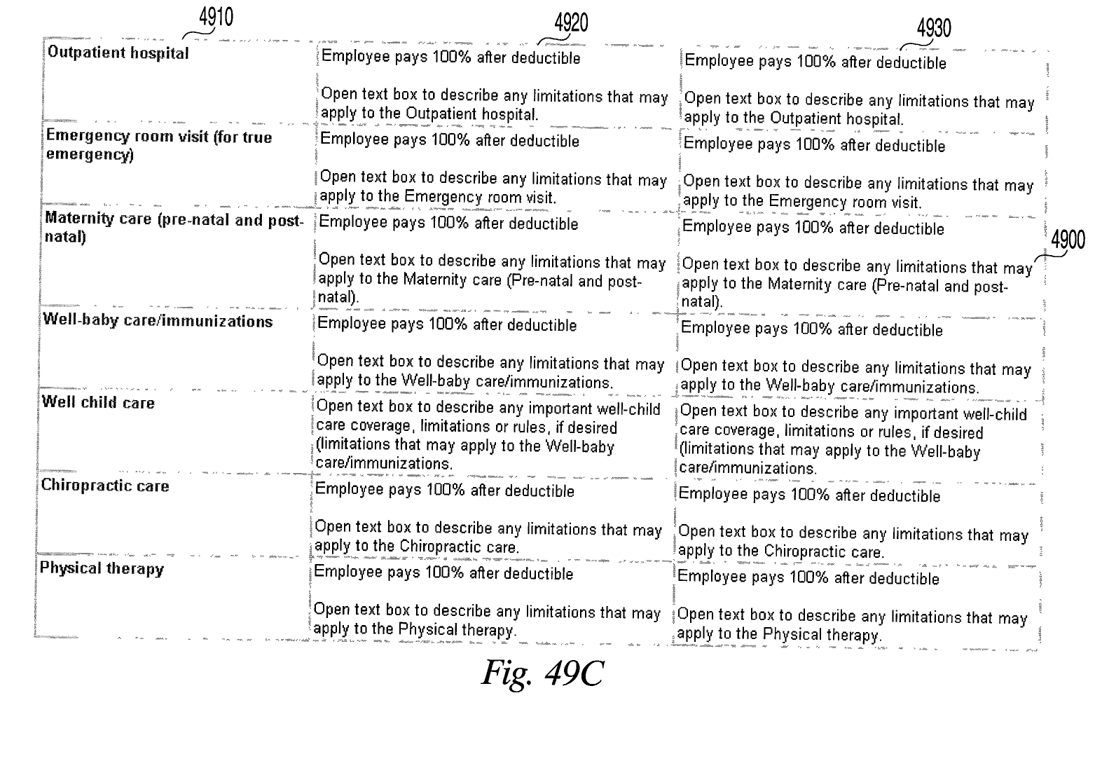

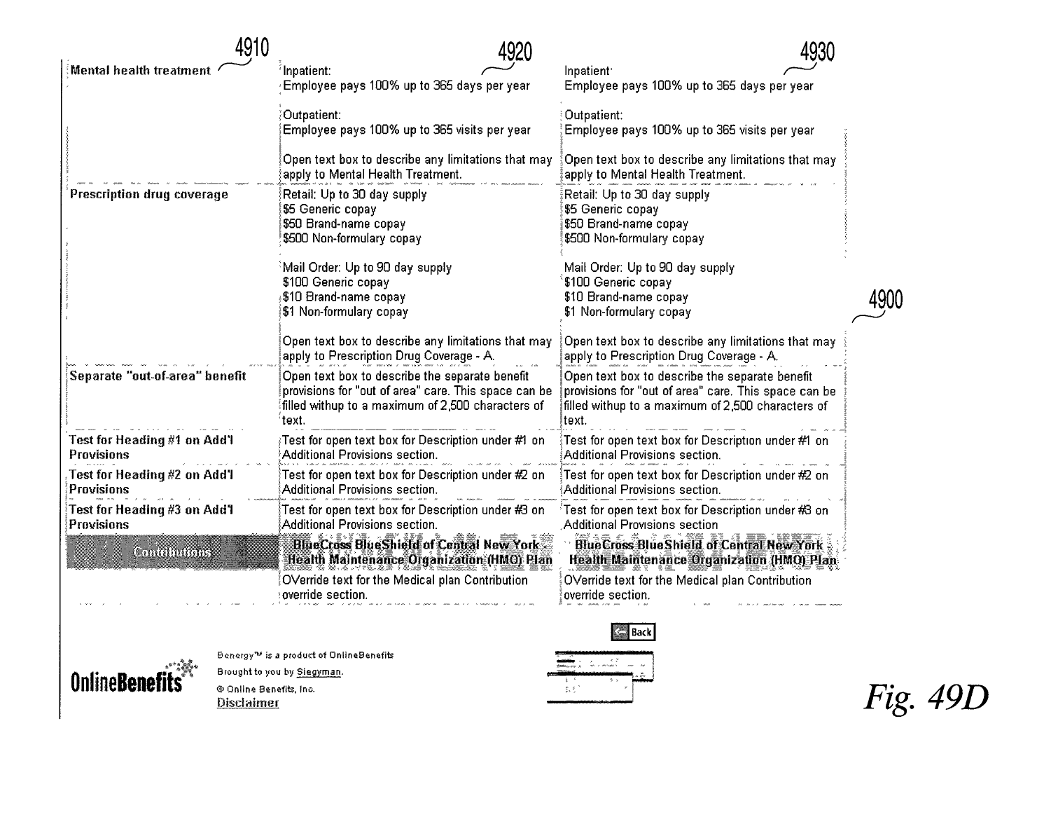

The second preferred embodiment also includes several features not present in the first preferred embodiment. The first of these features is a benefits plan comparison chart. An example benefits plan comparison chart is illustrated in FIGS. 49A-49D. The chart 4900 comprises three columns 4910, 4920, 4930. The first column 4910 comprises a list of benefits plan provisions, such as deductible, out-of-pocket maximum, copayment per physician office visit, etc. Each row in the chart 4900 includes in columns 4920 and 4930 the benefits plan provision information corresponding to the provision listed in that row in column 4910. A benefits plan comparison chart is generated by the system by querying a table of benefits plan information, such as Medical table 601 for the benefits plan provision for each plan represented in the chart, and populating the rows of the table with information from the corresponding plans.

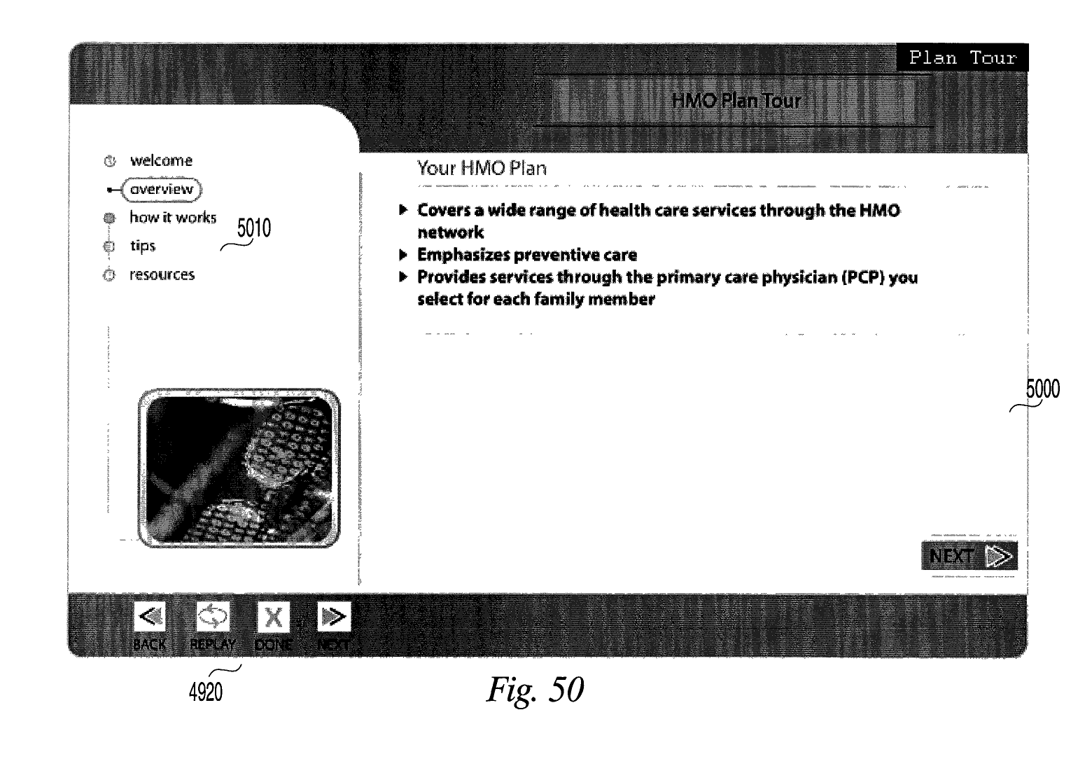

The second preferred embodiment also comprises one or more benefits plan tours. An example preferred benefits plan tour is schematically illustrated in FIG. 50. The tour 5000 is preferably composed in Flash, a multimedia scripting system available from Macromedia, Inc., 600 Townsend Street, San Francisco, Calif. The tour is preferably divided into sections (e.g. welcome, overview, etc.), which are preferably available by selecting icons on a navigation bar 5010. Within each section, controls 5020 for moving forward to the next section, back to the previous section, stopping or replaying the current section may be selected.

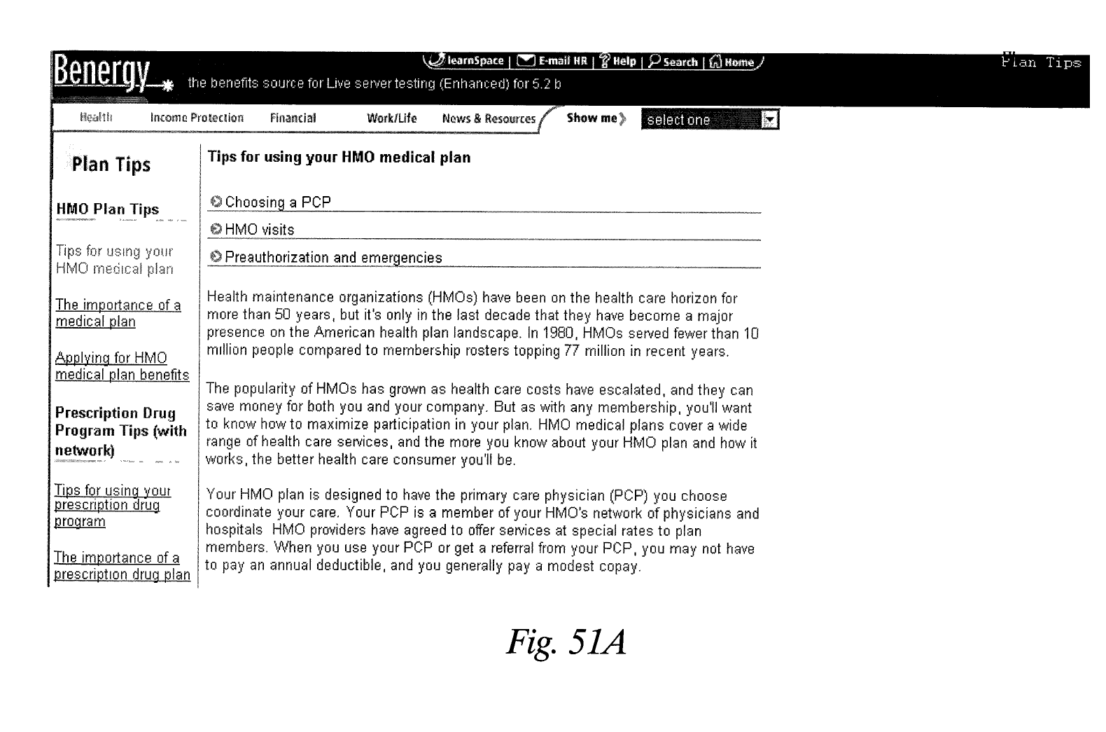

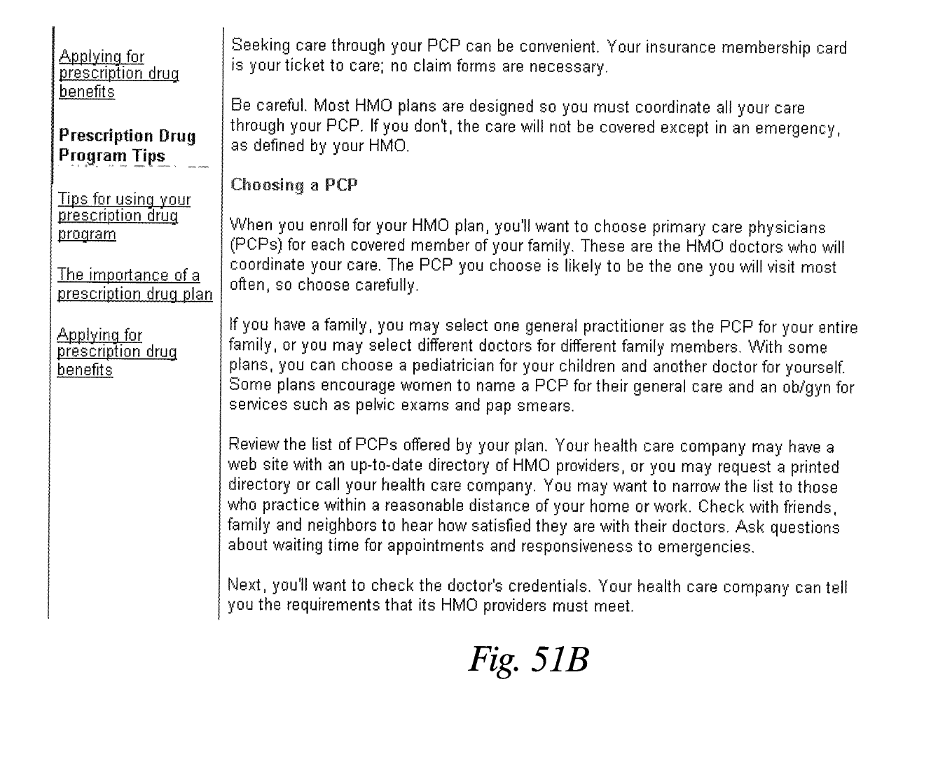

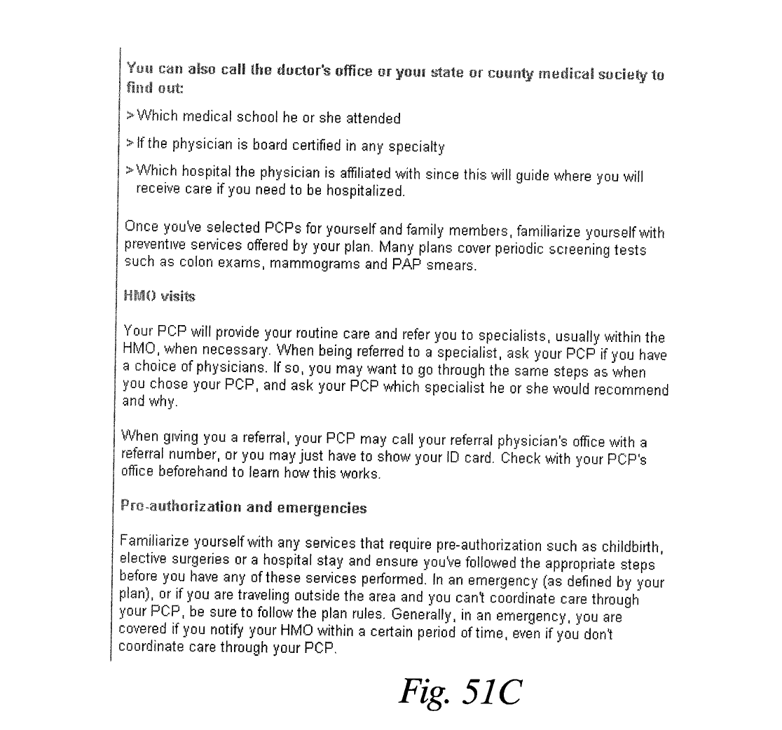

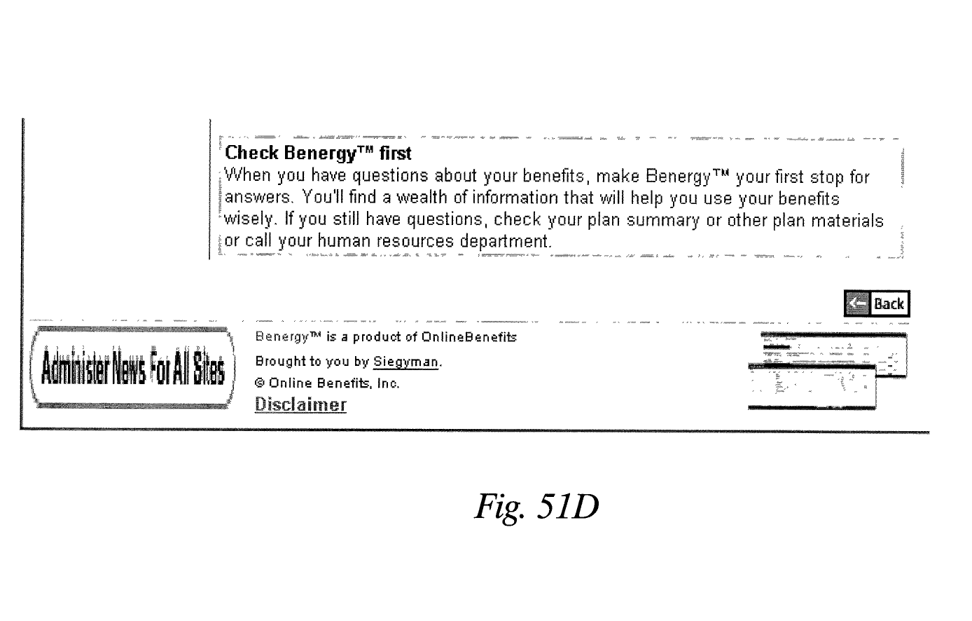

The second preferred embodiment further comprises one or more benefits plan tips. An example benefits plan tips is illustrated in FIGS. 51A-51D. Tips preferably comprise short passages of text on particular topics of interest in connection with a particular type of benefits plan.

While the present invention has been described with reference to a preferred embodiment, those skilled in the art will recognize that numerous variations and modifications may be made without departing from the scope of the present invention. This is especially true with regard to the presentation of information and configuration of web page displays, which may be varied greatly without departing from the scope of the present invention. Accordingly, it should be clearly understood that the embodiments of the invention described above are not intended as limitations on the scope of the invention, which is defined only by the claims that are now or may later be presented.

What is claimed is:

1. An employee benefits communication system comprising:
an electronic database of benefits plan information;
a Web server program executing on a Web server computer connected to the Internet, configured to authenticate users as brokers of employee benefits plans;
an application program executing on the Web server computer to update the database of benefits information in response to HTTP requests transmitted by authenticated brokers;
a Web site generation program that queries the database and incorporates information updated by brokers into text files comprising XML and employee benefits plans information;
a Web server program executing on a Web server computer connected to the Internet, configured to authenticate users as participants in an identified employee benefits plan and to transmit text files corresponding to the identified employee benefits plan in response to HTTP requests transmitted by authenticated participants in the identified employee benefits plan.

2. In a communications network having a server system and at least one client system, a method for building a human resources web site comprising the steps of:
a) maintaining at the server system first benefits plan information;
b) receiving from the client system second benefits plan information; and
c) automatically generating a web site based on the first and second benefits plan information.

3. The method of claim 2 wherein the second benefits plan information comprises company information, the company information comprising data regarding a company's benefits plans.

4. The method of claim 3 further comprising the step of:
transmitting for display on the client system a company information questionnaire form.

5. The method of claim 2 wherein the second benefits plan information comprises medical information, the medical information comprising data regarding medical benefits plans.

6. The method of claim 5 further comprising the step of:
transmitting for display on the client system a medical information questionnaire form.

7. The method claim 2 wherein the second human resources information comprises dental information, the dental information comprising data regarding dental benefits plans.

8. The method of claim 7 further comprising the step of:
transmitting for display on the client system a dental information questionnaire form.

9. The method of claim 2 wherein the first benefits plan information comprises Web resource information.

10. In a communications network having a server system and at least one client system, a method for maintaining a human resources web site comprising the steps of:
a) maintaining at the server system at least one record of benefits plan information;
b) receiving from the client system a command, the command corresponding to an operation to be performed on the record of benefits plan information;
c) updating the record of benefits plan information according to the command; and
d) automatically generating a web site based on the updated record of benefits plan information.

11. The method of claim 14 further comprising the step of:
receiving from the client system login information.

12. The method of claim 11 wherein the login information corresponds to a broker, the broker having access to a record of benefits plan information regarding companies associated with the broker, the broker being able to update the record of human resource information regarding the companies associated with the broker.

13. The method of claim 11 wherein the login information corresponds to an administrator of a company, the administrator having access to a record of benefits plan information regarding the administrator's company, the administrator being able to update the record of human resource information regarding the administrator's company.

14. The method of claim 10 wherein the benefits plan information comprises Web resource information.

15. The method of claim 10 wherein the benefits plan information comprises contact information.

16. The method of claim 10 wherein the benefits plan information comprises frequently asked question information.

17. The method of claim 10 wherein the benefits plan information comprises forms information.

18. The method of claim 10 further comprising the step of maintaining at the server system at least one record comprising broker information.

19. In a communications network having a server system and at least one client system, a method for maintaining a human resources web site comprising the steps of:
a) maintaining at the server system at least one record of news information;
b) receiving from the client system a command, the command corresponding to an operation to performed on the record of news information at the server system;
c) updating the record of news information according to the command; and
d) automatically generating a web site based on the updated record of news information.

20. The method of claim 19 further comprising the step of:
receiving from the client system login information.

21. The method of claim 20 wherein the login information corresponds to a broker, the broker having access to a record of news information regarding companies associated with the broker, the broker being able to update the record of news information regarding the companies associated with the broker.

22. The method of claim 20 wherein the login information corresponds to a broker, the broker having access to a record of news information regarding the broker, the broker being able to update the record of news information regarding the broker.

23. The method of claim 20 wherein the login information corresponds to an administrator of a company, the administrator having access to a record of news information regarding the administrator's company, the administrator being able to update the record of news information regarding the administrator's company.

24. The method of claim 19 wherein the record of news information comprises broker information.

25. The method of claim 19 wherein the record of news information comprises company information.

26. In a communications network having a server system for use with at least one client system, a method for accessing a customized human resources web site comprising the steps of:
a) maintaining benefits plan information at the server system, the benefits plan information being associated with login information;
b) receiving login information from the client system,
c) transmitting to the client system a Web page, the Web page being determined based on the login information, the Web page having been automatically generated based on the human resource information associated with the login information.

27. The method of claim 26 wherein the login information corresponds to a broker, the Web page comprises information regarding a corporate customer of the broker, and the broker can update the Web page.

28. The method of claim 26 wherein the login information corresponds to an administrator of a company, the Web page comprises information regarding the company, and the administrator can update the Web page.

29. The method of claim 10 wherein the benefits plan information comprises at least one benefits plan tip.

30. The method of claim 10 wherein the benefits plan information comprises at least one benefits plan tour.

31. The method of claim 10 further comprising the step of generating a chart comparing one or more provisions of at least two benefits plans.
